(19) United States
(12) Patent Application Publication
(10) Pub. No.: US 2026/0214047 A1
(43) Pub. Date: Jul. 23, 2026

(54) PATH-FINDING DEVICE, PATH-FINDING METHOD, AND PATH-FINDING PROGRAM

(71) Applicant: NTT, Inc., Tokyo (JP)

(72) Inventors: Kojun Koshiji, Musashino-shi, Tokyo (JP); Hiroshi MATSURA, Musashino-shi, Tokyo (JP); Hanami YOKOI, Musashino-shi, Tokyo (JP); Tatsuya MATSUKAWA, Musashino-shi, Tokyo (JP); Takashi MIYAMURA, Musashino-shi, Tokyo (JP); Yasuharu KANEKO, Musashino-shi, Tokyo (JP); Takayuki FUJII, Musashino-shi, Tokyo (JP)

(21) Appl. No.: 19/134,960

(22) PCT Filed: Dec. 22, 2022
(86) PCT No.: PCT/JP2022/047300

§ 371 Date: Jun. 2, 2025

(51) Int. Cl. H04L 45/247; H04L 45/128

(52) U.S. Cl. CPC H04L 45/247; H04L 45/128

(57) ABSTRACT

A route search device (1) includes a storage unit (4) that stores cost and SRLG information set to each of edges, a section division unit (31) that sets a search section from a start point node via an end point node to the start point node again and divides the search section into a plurality of sections, and a route search unit (32) that creates a route of the entire search section by sequentially searching for a route in each section based on the cost set to each of the edges and creates a 0-system route and a 1-system route by dividing the route of the entire search section at the end point node. When a route in each section is sequentially searched for, the route search unit (32) records the SRLG information of the searched route and edge and searches for a route for which the SRLG information does not overlap between the 0-system route and the 1-system route.

### TECHNICAL FIELD

The present invention relates to a route search device, a route search method, and a route search program.

### BACKGROUND ART

An optical path network, which implements communication by an optical signal, is a backbone network such as an Internet protocol (IP) communication network. The optical path network includes a plurality of nodes and edges (also referred to as links) connecting the plurality of nodes.

In the optical path network, cost required for communication varies for each edge, and thus, it is required to design a route while taking into account cost.

Examples of a route design method include a method of obtaining a route with the lowest cost from a start point node to an end point node (hereinafter, also referred to as “shortest route”), such as a Dijkstra method.

Here, in the optical path network, it may be required to design a plurality of routes by making routes redundant in order to ensure reliability.

As a method of designing a plurality of routes, a method (K-SPF scheme) of efficiently searching for a plurality of routes from a start point node to an end point node has been proposed (see Non Patent Literature 1). In this method, by storing a plurality of routes passing from the start point node to the end point node for each node in a route search process, it is possible to output a plurality of routes when reaching the end point node.

While there are various requirements when such a plurality of routes are designed, it is required that the routes (nodes, edges, and the like) do not overlap with each other.

In addition, when a route with higher reliability is designed, in some cases, a node to be passed through is designated. In this case, the simplest approach is to divide the search section in accordance with the order of passing-through and to execute route search in each section.

However, in a large-scale network, if the designated number of via nodes increases, the number of times of route search increases. In addition, in consideration of conditions such as a condition of not passing through the same node or edge twice, that is, a condition that nodes or routes do not overlap with each other, it is necessary to obtain not only the shortest route but also a plurality of route candidates such as the second route, the third route, . . . , and the like, which results in an enormous amount of calculation.

On the other hand, when an optical path network is constructed, in a case where a main route (hereinafter, referred to as a “0-system route”) and its redundant routes (hereinafter, the first route is referred to as a “1-system route”, and the second route is referred to as a “2-system route” . . . ) are designed, a shared risk link group (SRLG) may be taken into account. The SRLG means a group that shares a risk in a case where a failure occurs in a shared resource in a series of links that share the resource.

As the SRLG, information on a conduit (for example, a physical communication path for allowing an optical fiber, or the like, to pass through) through which each edge actually passes and information on an area related to a disaster area such as earthquake resistance, liquefaction, or power outage are held as the SRLG information for each edge. In the route design, as risk management, it is necessary to prevent the SRLG information from overlapping between the routes such as the 0-system route and the 1-system route. Note that a situation where the SRLG information does not overlap between the respective routes may be hereinafter referred to as “SRLG disjoint”.

For example, as illustrated in FIG. 40A, in a case where a node A is designated as a start point node, a node Z is designated as an end point node, and a node B is designated as a via node in the main route (0-system route), it is assumed that a route of the node A→C→B→Z is set as the 0-system route (main route). Here, the SRLG information of the edge (link) between the node A and the node C is <conduit 4, conduit 5>. Then, in a case where a node E that is a via node in the redundant route (1-system route) is designated, for example, the node A→D→E→Z is set as the 1-system route (redundant route).

Here, the SRLG information between the nodes A to D is <conduit 1, conduit 3>, and an edge (link) of the nodes A to D is selected as the (SRLG disjoint) 1-system route that does not overlap with the conduit information <conduit 4, conduit 5> of the 0-system route.

Note that, in FIG. 40A, a logical edge A-B and a logical edge A-D are represented as different routes.

However, as illustrated in FIG. 40B, the logical edge A-B is set to <conduit 1, conduit 2> as a physical edge A-B, and the logical edge A-D is set to <conduit 1, conduit 3> as a physical edge A-D. Thus, it means that <conduit 1> is common and the SRLG overlaps. In such a case, it is required to select the 0-system route and the 1-system route in which <conduit 1> does not overlap.

In consideration of this SRLG, a remove and find (RF) scheme (see Non Patent Literature 2) and a transform and find (TF) scheme (see Non Patent Literature 3) are known as methods for designing the 0-system route and the 1-system route.

### CITATION LIST

### Non Patent Literature

Non Patent Literature 1: Hiroshi Matsuura, “Multipath Routing Algorithm Applied to Cloud Data Center Services”, IEICE TRANS. COMMUN., VOL. E95-B, NO. 8 Aug. 2012.
Non Patent Literature 2: Eiji Oki, et. al., “A Disjoint Path Selection Scheme with SRLG in GMPLS Networks”, IEEE COMMUNICATIONS LETTERS, VOL. 6, NO. 9 Sep. 2002.
Non Patent Literature 3: Yongqiang, et. al., “A Minimum Cost Active and Backup Path Algorithm with SRLG Constraints”, IEEE International Conference on Internet Computing for Science and Engineering, 2012.

### SUMMARY OF INVENTION

### Technical Problem

In the route search method (RF scheme) in which the SRLG is taken into account described in Non Patent Literature 2, the shortest route is first obtained as the 0-system route by the Dijkstra method, and edges (links) belonging to all the SRLGs to which the edges used in the route belong are deleted. Thereafter, the 1-system route (redundant route) is searched for again by the Dijkstra method to obtain the 0-system and 1-system routes that are completely SRLG disjoint.

However, in the RF scheme, as the number of edges (rings) belonging to one SRLG increases, the number of links deleted after the first 0-system route is generated increases, and there is a possibility that the 1-system route cannot be generated.

In addition, in the RF scheme, the 0-system route is first calculated and fixed by the Dijkstra method, and thus, there is a possibility that cost minimization of the 0-system route and the 1-system route is lost. In other words, the 0-system route is fixed, and thus, it is not possible to select the optimum 0-system route in consideration of the SRLG and the cost. Furthermore, Non Patent Literature 2 does not describe a method for coping with a case where via nodes are designated in the 0-system route and the 1-system route and cannot cope with the case.

In addition, in the route search method (TF scheme) in which the SRLG is taken into account described in Non Patent Literature 3, first, the shortest route is obtained as the 0-system route by the Dijkstra method. Thereafter, edge cost of the edges belonging to the SRLG to which the edges used by the shortest route belong is increased. The edge cost is increased in proportion to a degree of importance and a degree of influence of the SRLG. Then, the 1-system route (redundant route) is searched for again by the Dijkstra method. As a result, in the 1-system route, it is difficult to select a route of the edges belonging to the same SRLG as the 0-system route.

If an edge (SRLG joint edge (link) ) in which the SRLG overlaps is generated in the 0-system route and the 1-system route, only the link is replaced with the SRLG disjoint route. Alternatively, in a case where a degree of influence of the SRLG is within an allowable range, the route is set as it is.

However, the TF scheme has the following problems.

Compared with the RF scheme, it takes time to reset the edge cost, narrow down the 1-system route in a case where the SRLG overlaps, and the like.

It is necessary to set the degree of importance (the degree of danger in a case where the SRLG overlaps in the 0/1-system) for each SRLG group, and it takes time and effort to set the degree of importance for each SRLG group, and thus, in some cases, setting cannot be actually performed.

Link cost belonging to the same SRLG as the edges (links) used in the 0-system route increases, and thus, the link cost set according to an original distance, or the like, is hardly reflected in the 1-system route.

In addition, the 0-system route is the main route, and thus, it is not possible to obtain optimality with respect to cost minimization by combining the 0-system route and the 1-system route.

Furthermore, Non Patent Literature 3 does not describe a method for coping with a case where via nodes are designated in the 0-system route and the 1-system route and cannot cope with the case.

The present invention has been made in view of such points, and an object of the present invention is to provide a route search device that searches for a plurality of routes avoiding overlapping of an SRLG while suppressing cost of each route.

### Solution to Problem

A route search device according to the present invention is a route search device that searches for a 0-system route that is a main route and a 1-system route that is a redundant route, which are routes from a start point node to an end point node, in a network including a plurality of nodes connected by edges, the route search device including:
a storage unit that stores cost and shared risk link group (SRLG) information set to each of the edges;
a section division unit that sets a search section from the start point node via the end point node to the start point node again and divides the set search section into a plurality of sections; and
a route search unit that creates a route of the entire search section by sequentially searching for a route in each section based on the cost set to each of the edges and creates the 0-system route and the 1-system route by dividing the route of the entire search section at the end point node,
in which when a route in each section is sequentially searched for, the route search unit records the searched route and the SRLG information of an edge indicated by the route, and when a route in a next section is searched for, the route search unit searches for a route that does not overlap with a route in a previous section and searches for a route in each section from the end point node to the start point node so that the SRLG information does not overlap with the SRLG information of the route searched for in each section from the start point node to the end point node.

### Advantageous Effects of Invention

According to the present invention, it is possible to search for a plurality of routes avoiding overlapping of an SRLG while suppressing cost of each route.

### BRIEF DESCRIPTION OF DRAWINGS

FIG. 1 is an explanatory diagram illustrating a configuration example of an optical path network to which a route search device according to the present embodiment is to be applied.

FIG. 2 is a functional block diagram illustrating a configuration of the route search device according to the present embodiment.

FIG. 3 is a flowchart indicating flow of processing of the route search device according to the present embodiment.

FIG. 4 is a flowchart indicating flow of section search processing of the route search device according to the present embodiment.

FIG. 5 is a view illustrating an example of an optical path network in which search processing is performed.

FIG. 6 is a view for explaining an example of the search processing in a section 1.

FIG. 7 is a view for explaining an example of the search processing in the section 1.

FIG. 8 is a view for explaining an example of the search processing in the section 1.

FIG. 9 is a view for explaining an example of the search processing in the section 1.

FIG. 10 is a view for explaining an example of the search processing in the section 1.

FIG. 11 is a view for explaining an example of the search processing in the section 1.

FIG. 12 is a view for explaining an example of the search processing in the section 1.

FIG. 13 is a view for explaining an example of the search processing in the section 1.

FIG. 14 is a view for explaining an example of the search processing in the section 1.

FIG. 15 is a view for explaining an example of the search processing in a section 2.

FIG. 16 is a view for explaining an example of the search processing in the section 2.

FIG. 17 is a view for explaining an example of the search processing in the section 2.

FIG. 18 is a view for explaining an example of the search processing in the section 2.

FIG. 19 is a view for explaining an example of the search processing in the section 2.

FIG. 20 is a view for explaining an example of the search processing in the section 2.

FIG. 21 is a view for explaining an example of the search processing in the section 2.

FIG. 22 is a view for explaining an example of the search processing in a section 3.

FIG. 23 is a view for explaining an example of the search processing in the section 3.

FIG. 24 is a view for explaining an example of the search processing in the section 3.

FIG. 25 is a view for explaining an example of the search processing in the section 3.

FIG. 26 is a view for explaining an example of the search processing in the section 3.

FIG. 27 is a view for explaining an example of the search processing in the section 3.

FIG. 28 is a view for explaining an example of the search processing in the section 3.

FIG. 29 is a view for explaining an example of the Search processing in the section 3.

FIG. 30 is a view for explaining an example of the search processing in the section 3.

FIG. 31 is a view for explaining an example of the search processing in the section 3.

FIG. 32 is a view for explaining an example of the search processing in a section 4.

FIG. 33 is a view for explaining an example of the search processing in the section 4.

FIG. 34 is a view for describing an example of the search processing in the section 4.

FIG. 35 is a view for explaining an example of the search processing in the section 4.

FIG. 36 is a view for explaining an example of the search processing in the section 4.

FIG. 37 is a hardware configuration diagram illustrating an example of a computer that implements functions of the route search device according to the present embodiment.

FIG. 38 is a view for explaining outline of processing of a route search device according to Modification 1.

FIG. 39 is a view for explaining outline of processing of a route search device according to Modification 2.

FIG. 40A is a view for explaining SRLG information (conduit) set to an edge.

FIG. 40B is a view for explaining an example where the SRLG information overlaps in one edge.

### DESCRIPTION OF EMBODIMENTS

Next, an embodiment for carrying out the present invention (hereinafter, referred to as the “present embodiment”) will be described with reference to the drawings.

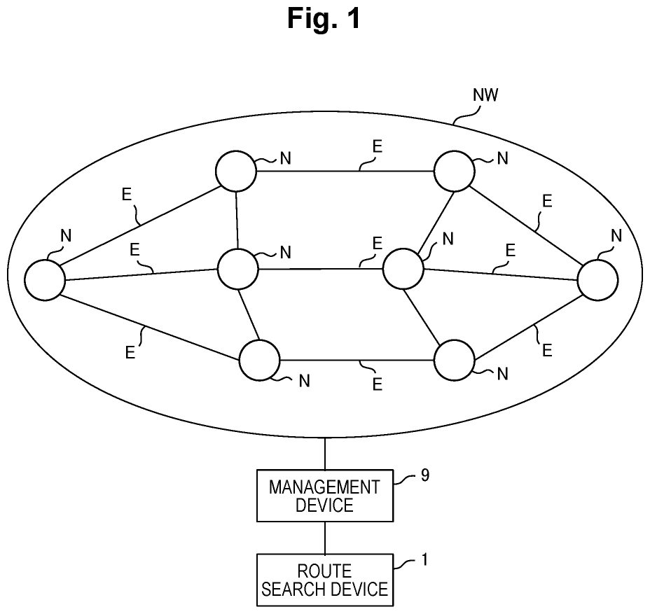

FIG. 1 is an explanatory diagram illustrating a configuration example of an optical path network (optical transport network) to which a route search device 1 according to the present embodiment is to be applied.

As illustrated in FIG. 1, the optical path network (NW) includes a plurality of nodes N and edges E connecting the nodes N.

The node N is configured as, for example, a transmission device such as an optical cross connect (OXC) device.

FIG. 1 illustrates a mesh-type optical path network in which the nodes N are mutually connected to adjacent nodes N. Note that the respective nodes N can be connected to other nodes and terminals (not illustrated) and can output and input optical signals from other nodes and terminals.

The optical path network is provided with a management device 9 that manages the optical path network. The route search device 1 acquires information on the optical path network from the management device 9 and searches for and designs a transmission route in the optical path network. The management device 9 manages transmission of an optical signal to be performed in the optical path network based on the route designed by the route search device 1.

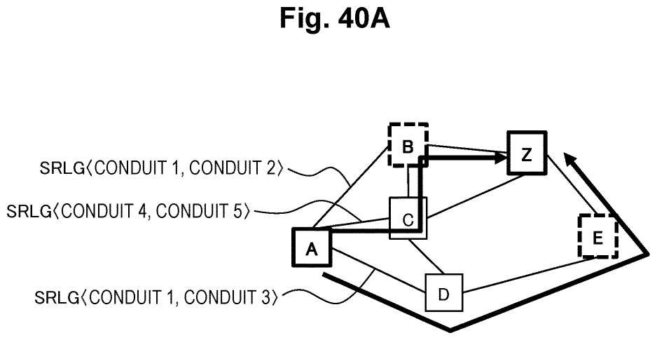

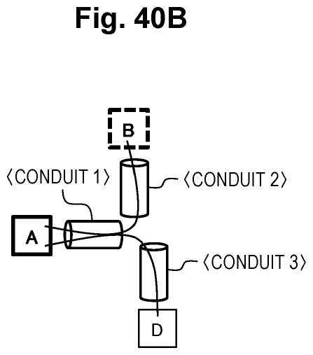

The transmission route is a transmission route of the optical signal from a start point node to an end point node and indicates the edges E and the nodes N through which the optical signal passes between the start point node and the end point node. Hereinafter, the “transmission route” is also simply referred to as a “route”. In addition, when simply described as an “edge” in the present embodiment, it means a logical edge (link) connecting the nodes N. This logical edge is actually constituted with a physical edge (physical communication path for allowing an optical fiber, or the like, to pass through) such as a conduit (see FIG. 40B).

In the mesh-type optical path network, even between the same start point node and end point node, a plurality of different routes can be designed by making the nodes N to be passed through and edges E different. By designing such redundant routes by the route search device 1, even if a failure occurs during transmission of an optical signal through any of the routes, transmission of the optical signal can be continued by switching to another route.

Here, cost for transmitting the optical signal via the edge E is set to each edge E. The cost is determined according to, for example, a distance between the nodes N connected by the edge E. Further, in each edge E, “SRLG ID” is set as an identifier of an SRLG (shared risk link group) through which each edge E passes. The SRLG ID is, for example, a “conduit ID” which is an identifier of a conduit, an “area ID” which is an identifier of an area, or the like. Hereinafter, SRLG ID is referred to as “SRLG information”. Further, a plurality of pieces of SRLG information may be included in one edge E.

In a case where the routes are made redundant, it is not desirable that cost of one route be extremely high as a result of suppressing cost of the other route to be low.

Thus, the route search device 1 performs route design so as to reduce cost of a combination of the main route and the redundant route. In addition, the route search device 1 avoids edge overlapping and SRLG overlapping between the main route and the redundant route. Further, the route search device 1 can store an attribute (attribute information) as to whether or not node overlapping between routes (for example, the 0-system route and the 1-system route) is possible in units of a node and determine node overlapping between routes according to the attribute information set for each node to design a route (details will be described later).

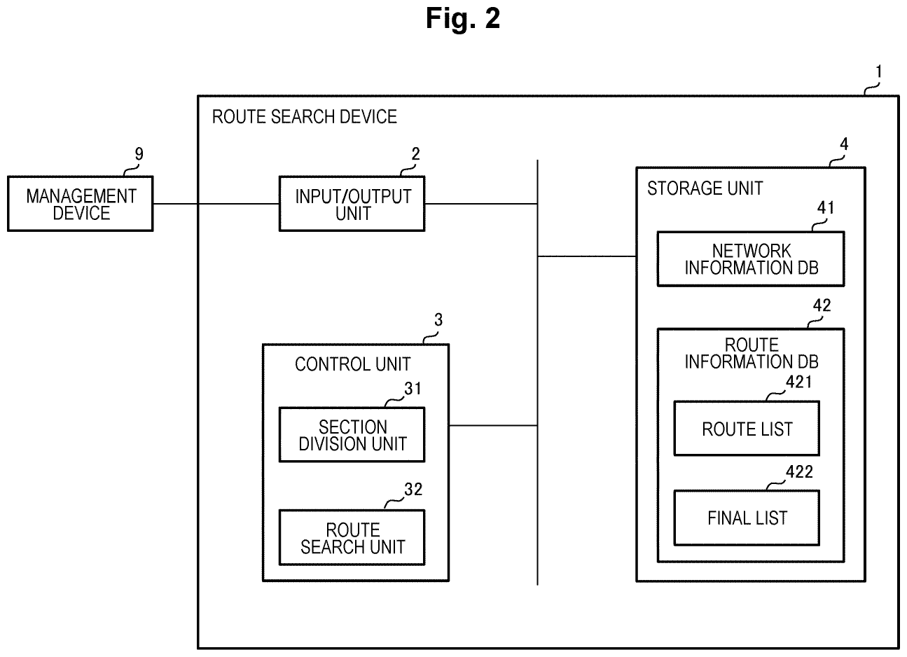

FIG. 2 is a functional block diagram illustrating a configuration of the route search device 1.

As illustrated in FIG. 2, the route search device 1 includes an input/output unit 2, a control unit 3, and a storage unit 4.

The input/output unit 2 includes an input/output interface (I/F), a communication I/F, and the like. The input/output unit 2 inputs/outputs data to/from the management device 9.

The input/output unit 2 also receives designation of a search condition input from an operator of the route search device 1. The search condition can include, for example, a start point node, an end point node, a via node, the number K of routes to be searched for in search processing (K is an integer equal to or greater than 1), the number L of combinations of the 0-system route and the 1-system route to be output (L is an integer equal to or greater than 1 and equal to or less than K), and the like. As the search condition, whether or not overlapping of the node N and the edge E is possible can be further designated.

The control unit 3 includes a section division unit 31 and a route search unit 32 as processing units that execute a route search method according to the present embodiment.

The section division unit 31 sets a search section in accordance with a search condition designated by an operator of the route search device 1 and divides the search section into a plurality of sections. In a case where no via node is designated, the section division unit 31 divides the search section into a plurality of sections having the node N at the start point and the node N at the end point as terminal points. In a case where a via node is designated in the 0-system route or the 1-system route, the section division unit 31 divides the search section into a plurality of sections having the node N at the start point, the node N at the end point, and each via node in the 0-system route and the 1-system route as terminal points.

The route search unit 32 creates a route of the entire search section by sequentially searching for a route of each section based on the cost set to each edge E. The route search unit 32 records the route searched for in each section and the SRLG information of the route. Then, when a route is searched for in the next section, the route search unit 32 searches for a route that does not overlap with the edge E in the previous section and records the searched route by adding the searched route to the route in the previous section.

In addition, the route search unit 32 performs route search while avoiding overlapping of the SRLG information between the routes (for example, between the 0-system route and the 1-system route). Further, the route search unit 32 determines whether or not node overlapping between routes (for example, between the 0-system route and the 1-system route) is possible based on the attribute information set to each node N, and if node overlapping is possible, performs route search under a condition that node overlapping between routes is allowed, and if node overlapping is not possible, performs route search under a condition that node overlapping between routes is not allowed.

The route search unit 32 creates a main route (0-system route) and a redundant route (1-system route) by finally dividing the created route of the search section at the node N at the end point. In other words, the route search device 1 according to the present embodiment creates a so-called one-stroke route connecting the 0-system route and the 1-system route and finally performs processing of dividing the one-stroke route.

Note that details of the processing of the section division unit 31 and the route search unit 32 will be described below together with flowcharts and specific examples.

The storage unit 4 includes a read only memory (ROM), a RAM, a hard disk drive (HDD), and the like, stores information necessary for the processing of the section division unit 31 and the route search unit 32 and temporarily stores processing results of the respective units. As an example, the storage unit 4 includes a network information database (DB) 41 and a route information DB 42.

The network information DB 41 stores information of the optical path network input from the management device 9. The network information DB 41 stores, for example, information regarding a network topology representing a connection relationship between the node N and the edge E and attribute information of the node N and the edge E. The attribute information of the edge E includes, for example, a distance of the edge E connecting nodes, cost set to each edge E, SRLG information set to each edge E, and the like. Furthermore, as the attribute information of the node N, information as to whether or not node overlapping is possible between respective routes such as the main route and the redundant route is stored for each node N, for example, as a Boolean attribute of “True” or “False”. Note that whether or not node overlapping is possible is set by an operator in consideration of, for example, a possibility of disaster at the time of disaster such as a level of processing performance of the node and earthquake resistance of a place (building) where the node is installed.

The route information DB 42 stores a route list 421 and a final list 422. The route created by the search processing of the route search unit 32 is recorded in the route list 421 and the final list 422. The route list 421 is provided corresponding to each of the nodes N constituting the optical path network. Details of the route list 421 and the final list 422 will be described below later together with details of the processing of the route search unit 32.

Hereinafter, flow of processing of the route search device 1 will be described with a specific example.

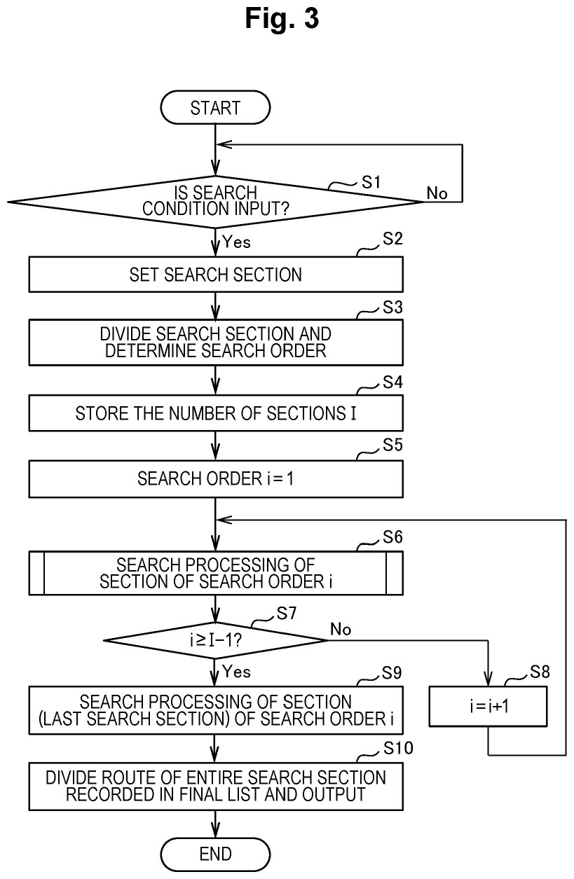

FIG. 3 is a flowchart indicating flow of processing of the route search device 1.

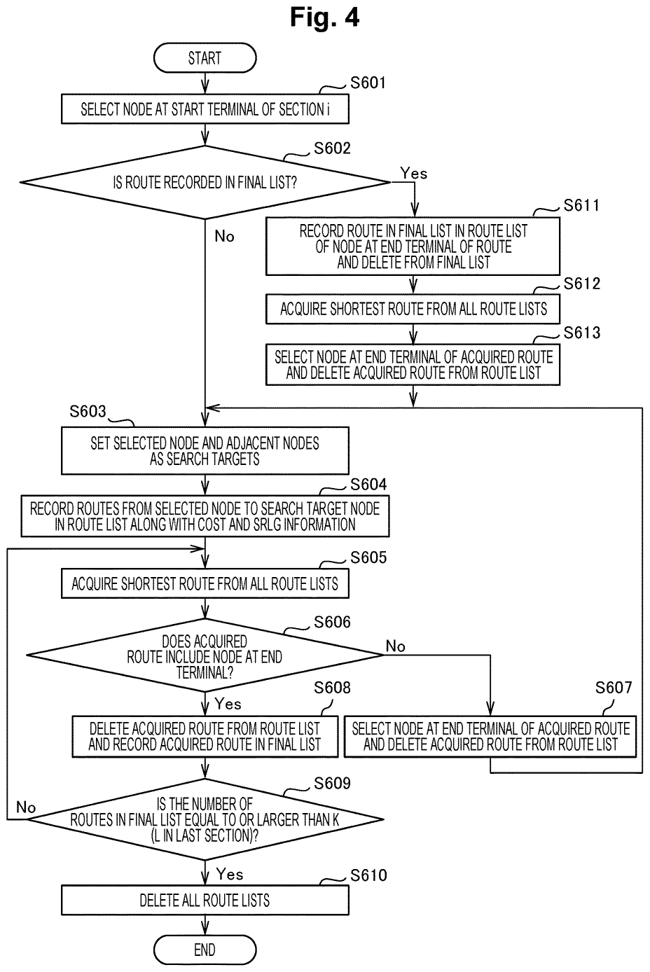

FIG. 4 is a flowchart indicating flow of section search processing.

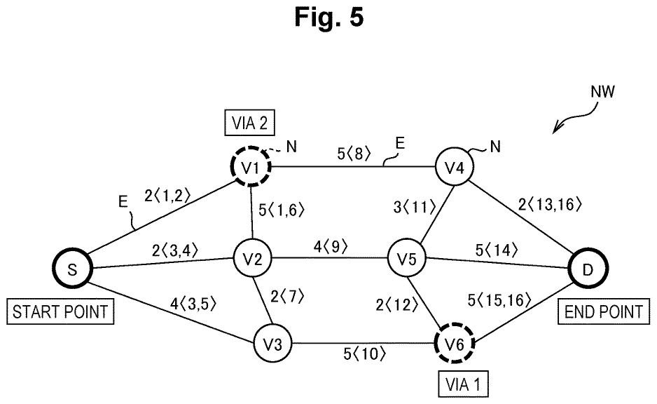

FIG. 5 is a view illustrating an example of the optical path network in which the search processing is performed. In FIG. 5, to distinguish the plurality of nodes N, individual reference signs (S, V1 to V6, and D) are given to the respective nodes N. In addition, the number attached to the edge E connecting the nodes indicates the cost set to the edge E and the SRLG information. For example, “2<1, 2>” described in the edge E between the node S and the node V1 indicates that the cost is “2” and, for example, “conduit 1, conduit 2” is set as the SRLG information.

As illustrated in FIG. 3, the route search device 1 determines whether or not a search condition has been input from the operator via the input/output unit 2 (FIG. 2) (step S1). If a search condition has not been input (step S1→No), the processing waits until a search condition is input. On the other hand, if a search condition has been input (step S1→Yes), the section division unit 31 (FIG. 2) sets a search section for a route in accordance with the search condition (step S2).

The section division unit 31 sets the search section with reference to information about a network topology of the optical path network stored in the network information DB 41 (FIG. 2). The search section is a section starting from the start point node, passing through the end point node, and reaching the start point node again.

Here, in a case where the via node is designated in the search condition, the section division unit 31 sets the search section in which the via node is arranged between the start point node and the end point node. The section division unit 31 arranges the via node designated in the 0-system route in the section from the start point node to the end point node. The section division unit 31 arranges the via node designated in the 1-system route in the section from the end point node to the start point node. Note that the number of via nodes arranged in each system (0-system or 1-system) is not limited to one, and a plurality of via nodes may be designated for each system as the search condition.

In the example of FIG. 5, in a case of searching for the 0-system route and the 1-system route between the designated two bases, description will be given assuming that a different arbitrary via node is designated for each of the 0-system/1-system routes, and the search condition is set as follows.
The start point node: the node S
The end point node: the node D
The via node of the 0-system route: the node V6
The via node of the 1-system route: the node V1
The number K of routes to be searched for in each section: 2
The number L of combinations of the 0-system route (main route) and the 1-system route (redundant route) to be output: 2 The attribute information of each node N is set such that node overlapping between the 0-system route and the 1-system route is allowed except for the node V2.
Each edge E may have a plurality of pieces of SRLG information (SRLG ID), and a conduit through which each edge E passes is referred to as the SRLG.

The section division unit 31 sets the search section of “the start point node S→the node V6→the end point node D→the node V1→the start point node S” according to these search conditions.

Returning to FIG. 3, the section division unit 31 divides the set search section and determines search order of the respective sections (step S3).

The section division unit 31 divides the search section with the start point node, the end point node, and the via node as terminal points. In the example of FIG. 5, the search section is divided into the following four sections with the start point node S, the end point node D, and the via nodes V6 and V1 as terminal points.
Section 1: the start point node S→the via node V6 (search order 1)
Section 2: the via node V6→the end point node D (search order 2)
Section 3: the end point node D→the via node V1 (search order 3)
Section 4: the via node V1→the start point node S (search order 4)

The section 1 and the section 2 are sections corresponding to the 0-system route, and the section 3 and the section 4 are sections corresponding to the 1-system route.

The section division unit 31 stores the number of divided sections I in the storage unit 4 (step S4).

The route search unit 32 sets the search order i=1 (step S5) and starts the search processing from the section of the search order 1 (step S6).

In the example of FIG. 5, the section division unit 31 stores the number of sections I=4 in the storage unit 4 and starts the search processing from the section 1 of the search order 1.

Upon execution of route search, the route search unit 32 searches for a route based on the following predetermined search logic.
Via nodes, start point node, and end point node other than the section of the search order i are excluded from additional nodes.
The route to be registered in each route list does not allow a loop passing through the same node twice in routes of the same system, but may allow node overlapping between different systems. The determination is made based on the attribute information attached to each node.
In a case where the SRLG information held by the target edge as the attribute overlaps with the SRLG information on the route of the other system, the edge is not selected.
The number of routes stored by the route search unit 32 for each node N is up to K. In a case where the number of routes is equal to or larger than K, K routes with lower cost (higher priority) are stored including the already stored routes.

Flow of processing in which the route search unit 32 searches for a route based on the predetermined search logic will be described with reference to the flowchart indicated in FIG. 4 and FIGS. 6 to 36.

### <Search Processing in Section 1>

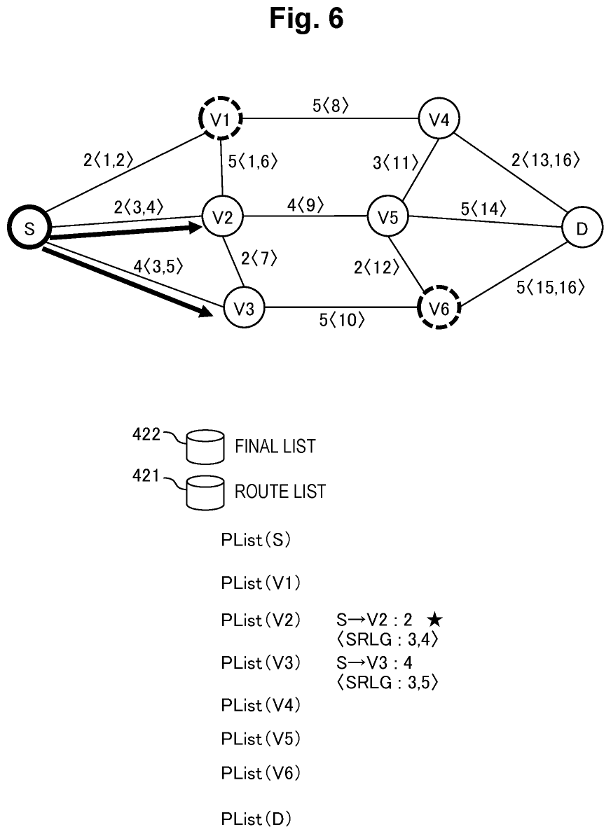

FIGS. 6 to 14 are views for explaining an example of the search processing in the section 1.

In the search processing of the 0-system route in the section 1, the route search unit 32 performs search processing with reference to the information on the network topology stored in the network information DB 41 and the cost set to each edge E.

In addition, the route search unit 32 performs search processing while recording the route and SRLG information of the route in the route list 421 and the final list 422 of the route information DB 42. In the following description, the route list 421 provided corresponding to each node is described in a form of “PList (node name)”. For example, the route list corresponding to the node V1 is described as PList (V1).

### <Search Processing in Section 1—First Time>

As illustrated in FIG. 4, the route search unit 32 selects the node N that is a start terminal of the section i (step S601).

In the example of FIG. 6, the route search unit 32 selects the start point node S that is the start terminal of the section 1 (the start point node S→the via node V6).

The route search unit 32 checks whether a route is recorded in the final list 422 of the route information DB 42 (step S602). In the search processing in the first section 1, no route is stored in the final list 422 (step S602: No), and thus, the route search unit 32 proceeds to step S603.

The route search unit 32 sets nodes adjacent to the selected node as search target nodes (step S603).

Here, to avoid overlapping of the nodes N and the edges E, the route search unit 32 excludes nodes designated as via nodes in other sections, the start point node, and the end point node from search targets.

In the example of FIG. 6, the nodes adjacent to the start point node S that is the selected node are the nodes V1, V2, and V3. Here, the node V1 is the via node included in the sections 3 and 4, and thus, the route search unit 32 excludes the node V1 from the search target and sets the nodes V2 and V3 as the search targets.

The route search unit 32 records a route from the selected node to the search target nodes in the route list 421 corresponding to the search target nodes together with the cost of the passing edge E and the SRLG information of the edge E (step S604). The route search unit 32 records the route in the format of “route: cost <SRLG information>”, for example.

In the example of FIG. 6, “S→V2:2 <SRLG: 3, 4>” is recorded in PList (V2), and “S→V3:4 <SRLG: 3, 5>” is recorded in PList (V3).

The route search unit 32 refers to all the route lists 421 recorded in the route information DB 42 and acquires the route with the lowest cost, that is, the so-called shortest route (step S605). The route search unit 32 determines whether the acquired route includes the node at an end terminal of the section (step S606).

In the example of FIG. 6, “S→V2:2” recorded in PList (V2) is the shortest route. In the drawings, the shortest route is marked with a star. This route does not include the node V6 that is the end terminal of the section 1 (step S606: No), and thus, the route search unit 32 proceeds to step S607.

### <Search Processing in Section 1—Second Time>

The route search unit 32 selects the node at the end terminal of the acquired route and deletes the acquired route from the route list 421 (step S607).

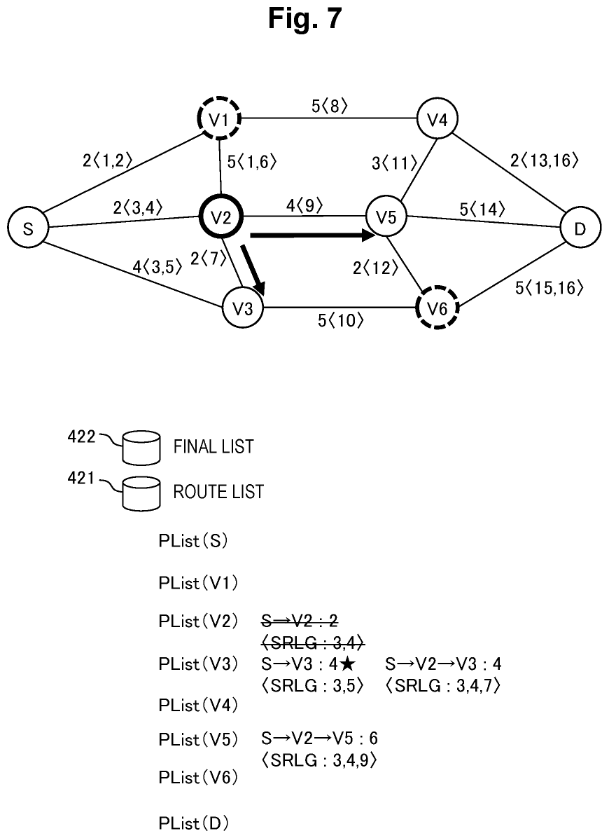

As illustrated in FIG. 7, the route search unit 32 selects the node V2 at the end terminal of the route “S→V2:2 <SRLG: 3, 4>” and delete the route “S→V2:2 <SRLG: 3, 4>” from PList (V2). Note that in the drawing, the deleted route is marked with a strikethrough.

As illustrated in FIG. 4, the route search unit 32 returns to step S603 and performs search processing similar to the first search processing (steps S603 to S606).

As illustrated in FIG. 7, the nodes adjacent to the node V2 that is the selected node are the nodes V1, V3, and V5. Here, the node V1 is the via node in the sections 3 and 4, and thus, the route search unit 32 excludes the node V1 from the search targets and sets the nodes V3 and V5 as the search targets (step S603).

Note that the route recorded in the route list 421 is not allowed to pass through the same node of the route (for example, in each of the 0-system route and the 1-system route) in the same system twice or more. In other words, a looped route is not allowed. Thus, in the second and subsequent search processing, the route search unit 32 excludes the nodes already described in the acquired route from the search targets. Note that the start point node S overlaps as the start terminal of the section 1 and the end terminal of the section 4. Thus, at the time of the search processing in the section 4, overlapping of the start point node S in the route is exceptionally allowed.

The route search unit 32 records routes obtained by adding one hop from the selected node V2 to the nodes V3 and V5 that are the search targets to the route “S→V2” deleted as the shortest route in PList (V3) and PList (V5) of the search targets, respectively (step S604). The route search unit 32 records “S→V2→V3:4 <SRLG: 3, 4, 7>” in PList (V3), and records “S→V2→V5:6 <SRLG: 3, 4, 9>” in PList (V5).

As described above, the route search unit 32 sets the node at the end terminal of the acquired shortest route as the selected node of the next search processing and can perform the route search with reduced cost by further expanding the search range from the selected node to the adjacent node in the shortest route. Furthermore, by proceeding with the search while sequentially recording the routes created by the search in the route list 421 of the corresponding nodes, it is possible to perform route search while avoiding overlapping of the nodes N and the edges E in the route in the same system.

The route search unit 32 refers to all the route lists 421, acquires “S→V3:4” that is the shortest route (step S605) and determines whether the acquired route includes the node V6 that is the end terminal of the section 1 (step S606).

Note that the route “S→V2→V3:4” having the same cost is recorded in PList (V3) in which the route “S→V3: 4” is recorded. As described above, when referring to all the route lists 421, in a case where there are routes with the same cost, the route search unit 32 can set a priority condition and select one of the routes.

As illustrated in FIG. 7, in a case where a plurality of routes having the same cost is recorded in PList (V3) that is the same route list 421, the priority condition can be set such that “the route previously registered in the route list 421” is selected using, for example, the first in first out rule.

Furthermore, in a case where routes with the same cost are recorded in the route lists 421 corresponding to different nodes, the priority condition can be, for example, set such that “the route with a smaller node number in the recorded route list 421” is selected. As an example, in a case where routes with the same cost are recorded in PList (V2) and PList (V3), the route search unit 32 can select the route of PList (V2).

Further, the priority condition can be set such that “the route in which the node at the end terminal of the route is close to the node at the start terminal” is selected, “the route with a small number of hops (the number of nodes to be passed through)” is selected, or the like. Note that, hereinafter, detailed description of the processing of selecting one of the routes having the same cost will be omitted.

In the example of FIG. 7, the acquired route “S→V3:4” does not include the node V6 at the end terminal of the section 1, and thus, the route search unit 32 further advances the search.

Note that, in the third and subsequent search processing, the same processing as the second search processing is performed, and thus, description of the already described steps of the flowchart of FIG. 4 will be omitted in the following description.

### <Search Processing in Section 1—Third Time>

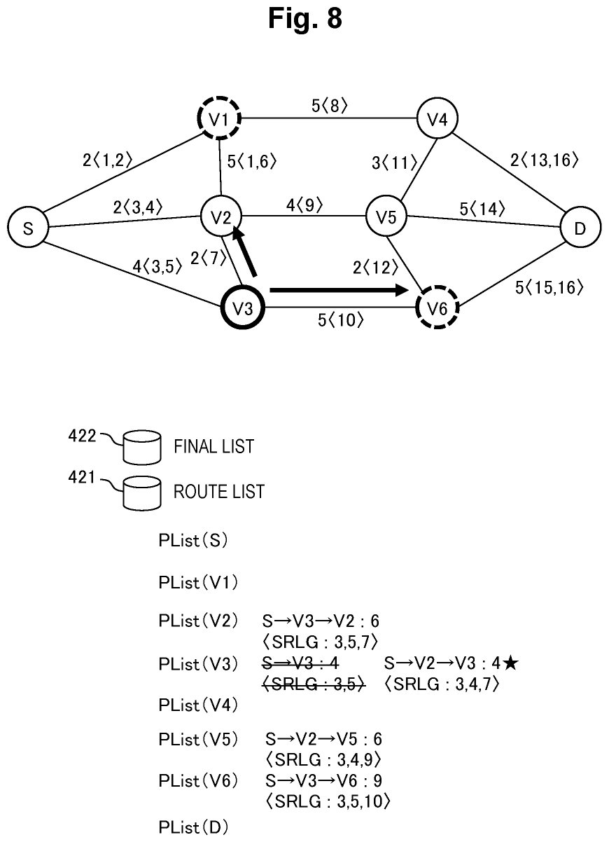

As illustrated in FIG. 8, the route search unit 32 selects the node V3 at the end terminal of the acquired route and deletes the route “S→V3:4 <SRLG: 3, 5>” from PList (V3).

The route search unit 32 sets the nodes V2 and V6 adjacent to the selected node V3 as the search targets, records the PList (V2) route “S→V3→V2:6 <SRLG: 3, 5, 7>”, and records the route “S→V3→V6:9 <SRLG: 3, 5, 10>” in PList (V6).

The route search unit 32 acquires the shortest route “S→V2→V3:4” from all the route lists 421. This route does not include the node V6 at the end terminal of the section 1, and thus, the route search unit 32 further advances the search.

### <Search Processing in Section 1—Fourth Time>

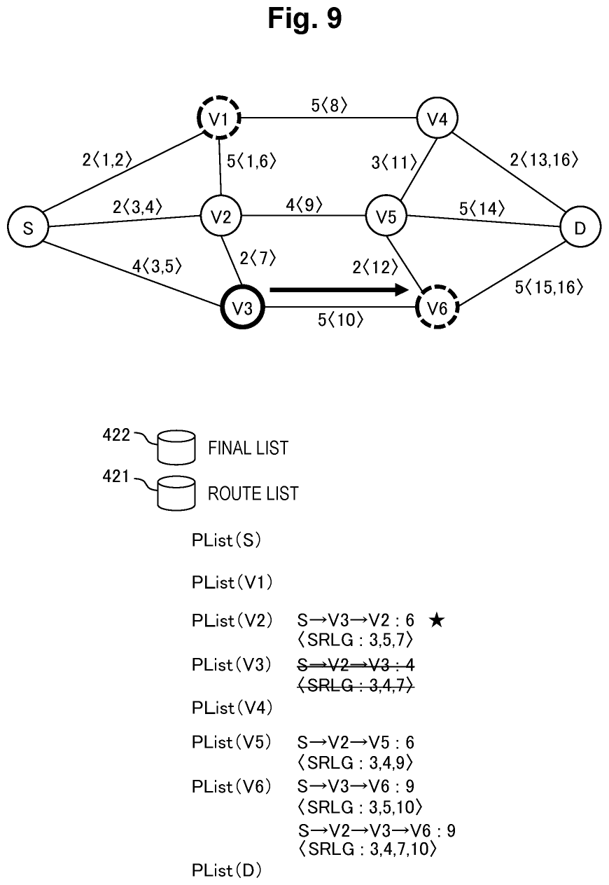

As illustrated in FIG. 9, the route search unit 32 selects the node V3 located at the end terminal of the acquired route and deletes the route “S→V2→V3:4 <SRLG: 3, 4, 7>” from PList (V3). The nodes adjacent to the selected node V3 are the nodes V2 and V6, but the route “S→V2→V3:4” already includes the node V2. Thus, the route search unit 32 excludes the node V2 from the search targets and sets the node V6 as the search target. The route search unit 32 records the route “S→V2→V3→V6:9 <SRLG: 3, 4, 7, 10>” in PList (V6).

The route search unit 32 acquires “S→V3→V2:6”, which is the shortest route, from all the route lists 421. This route does not include the node V6, and thus, the route search unit 32 further advances the search.

### <Search Processing in Section 1—Fifth Time>

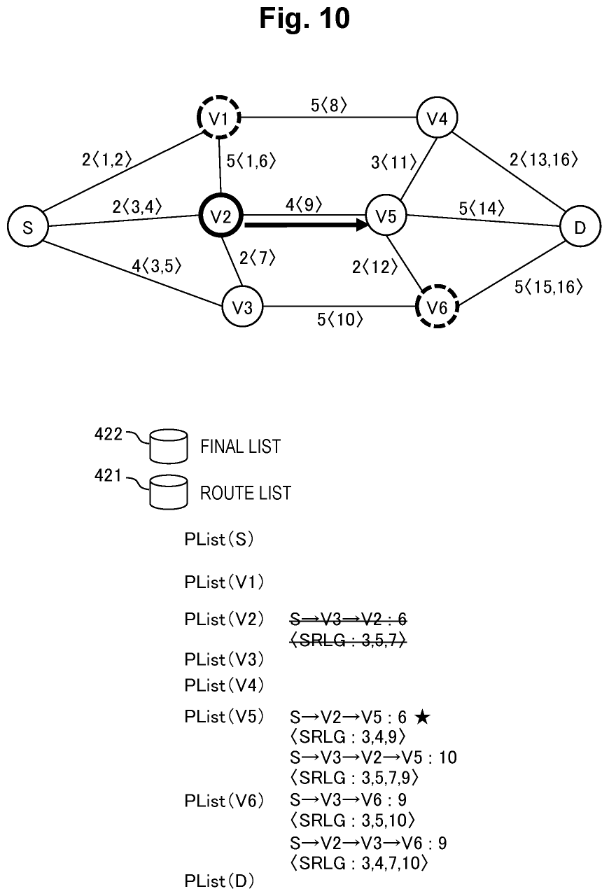

As illustrated in FIG. 10, the route search unit 32 selects the node V2 at the end terminal of the route “S→V3→V2:6” and deletes the route “S→V3→V2:6” from PList (V2). The nodes adjacent to the selected node V2 are the nodes V1, V3, and V5, but the node V1 is a via node included in the other section 3 and section 4 and the node V3 is included in the route “S→V3→V2:6”, and thus, the nodes V1 and V3 are excluded from the search targets. The route search unit 32 sets the node V5 as the search target and records a route “S→V3→V2→V5:10 <SRLG: 3, 5, 7, 9>” in PList (V5).

The route search unit 32 acquires “S→V2→V5:6”, which is the shortest route, from all the route lists 421. This route does not include the node V6, and thus, the route search unit 32 further advances the search.

### <Search Processing in Section 1—Sixth Time>

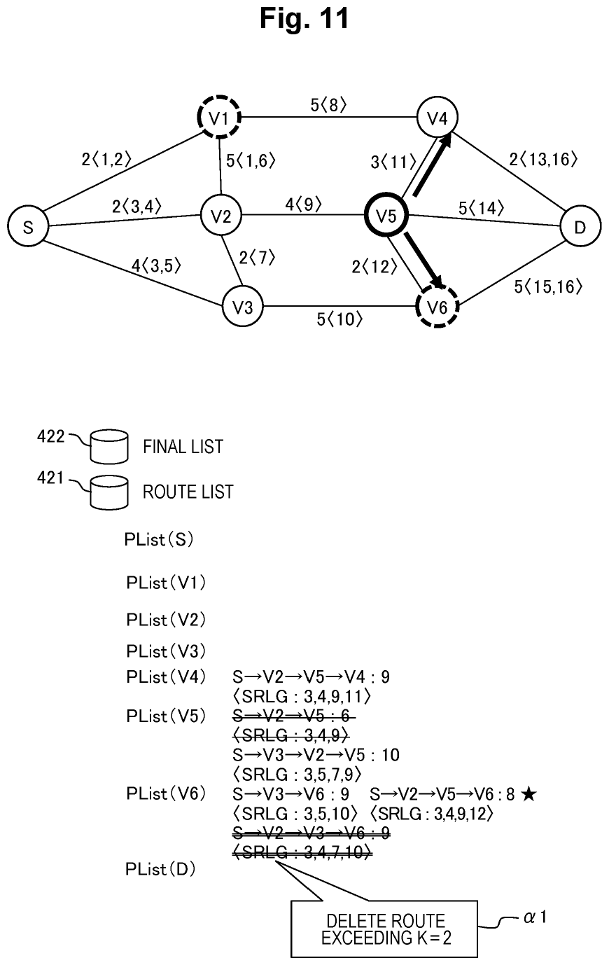

As illustrated in FIG. 11, the route search unit 32 selects the node V5 at the end terminal of the route “S→V2→V5:6” and deletes the route “S→V2→V5:6 <SRLG: 3, 4, 9>” from PList (V5). The route search unit 32 sets the nodes V4, V6 and D adjacent to the selected node V5 as the search targets. The node D is an end point node included in another section, and thus, the node D is excluded from the search targets.

The route search unit 32 records the route “S→V2→V5→V4:9 <SRLG: 3, 4, 9, 11>” in PList (V4) and records the route “S→V2→V5→V6:8 <SRLG: 3, 4, 9, 12>” in PList (V6).

Here, the number of routes recorded in PList (V6) is three, and thus, the number exceeds the number K=2 specified in the search condition. Thus, the route search unit 32 deletes one route with high cost from the routes recorded in PList (V6) (reference sign al in FIG. 11).

As illustrated in FIG. 11, the route search unit 32 deletes the route “S→V2→V3→V6:9 <SRLG: 3, 4, 7, 10>”. Here, the route “S→V3→V6:9” stored in PList (V6) is also the cost 9. As described above, in a case where there are routes with the same cost, it is possible to select the route to remain in the route list 421 by using the priority condition such as “the route with a small number of hops” or “the route previously recorded in the route list 421”.

The route search unit 32 acquires “S→V2→V5→V6:8”, which is the shortest route, from all the route lists 421. This route includes the node V6 that is the end terminal of the section 1 (FIG. 4, step S606: Yes).

In this case, the route search unit 32 proceeds to step S608, deletes the acquired route from the corresponding route list 421 and records the acquired route in the final list 422. In a case where the number of routes recorded in the final list 422 is less than K (step S609: No), the route search unit 32 returns to step S605.

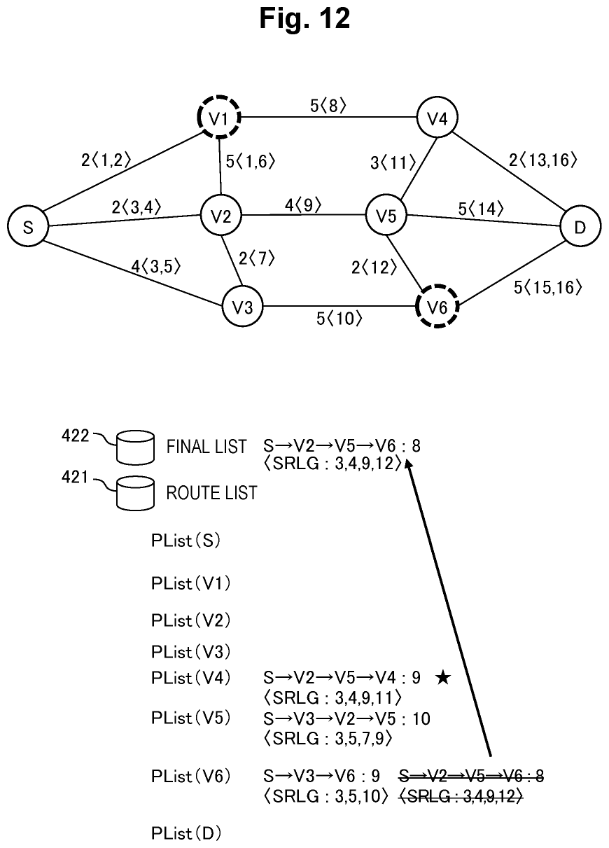

In the example of FIG. 12, the route search unit 32 deletes “S→V2→V5→V6:8 <SRLG: 3, 4, 9, 12>” from PList (V6) and records “S→V2→V5→V6:8 <SRLG: 3, 4, 9, 12>” in the final list 422. The number of routes recorded in the final list 422 is 1, which is less than K=2. The route search unit 32 acquires “S→V2→V5→V4:9”, which is the shortest route, from all the route lists 421. The node V6 is not included in this route, and thus, the route search unit 32 further advances the search.

### <Search Processing in Section 1—Seventh Time>

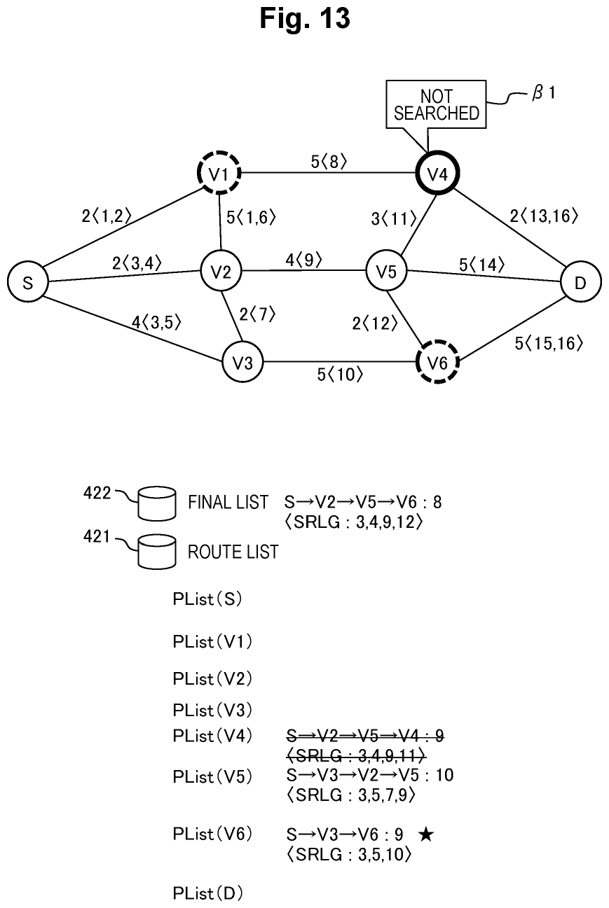

As illustrated in FIG. 13, the route search unit 32 selects the node V4 at the end terminal of the acquired route and deletes the route “S→V2→V5→V4:9 <SRLG: 3, 4, 9, 11>” from PList (V4). The nodes adjacent to the selected node V4 are nodes V1, V5 and D. The nodes V1 and D are via nodes and end point nodes included in other sections. The node V5 is included in the route “S→V2→V5→V4:9”. Thus, all the nodes are excluded from the search target. In this case, search for the adjacent node and recording of the route are not performed (reference sign β1 in FIG. 13).

The route search unit 32 acquires “S→V3→V6:9”, which is the shortest route, from all the route lists 421. This route includes the node V6 that is the end terminal of the section 1.

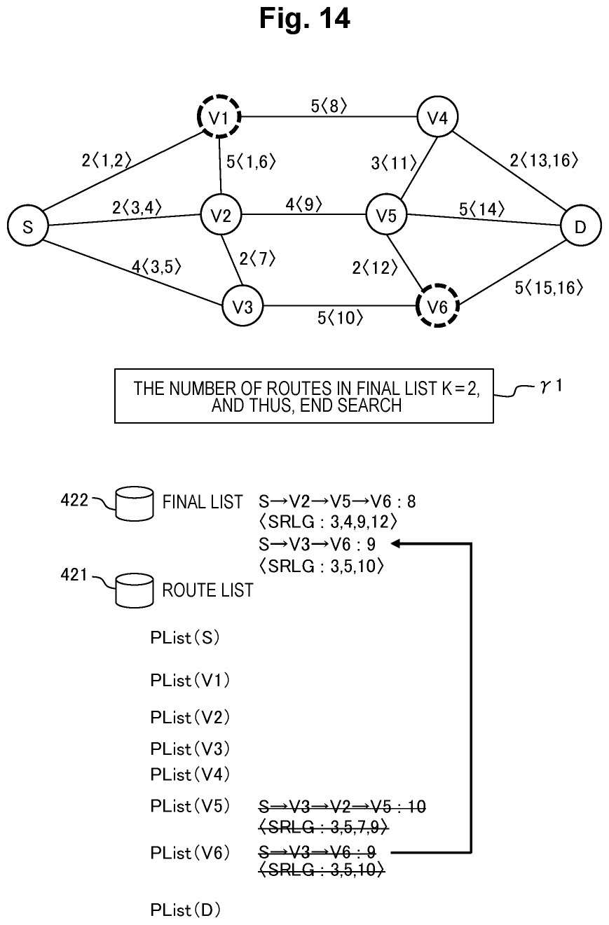

As illustrated in FIG. 14, the route search unit 32 deletes the route “S→V3→V6:9 <SRLG: 3, 5, 10>” from PList (V6) and records the route in the final list 422.

As illustrated in FIG. 4, in a case where the number of routes recorded in the final list 422 is equal to or larger than K (step S609: Yes), the route search unit 32 deletes all the routes recorded in the route list 421 corresponding to each node and ends the search processing in the section (step S610).

In the example of FIG. 14, the number of routes recorded in the final list 422 is K=2, and thus, the route search unit 32 deletes the route “S→V3→V2→V5:10 <SRLG: 3, 5, 7, 9>” of PList (V5) and ends the search processing of the section 1 (reference numeral γ1 in FIG. 14). As a result of the search processing in the section 1, two routes “S→V2→V5→V6:8 <SRLG: 3, 4, 9, 12>” and “S→V3→V6:9 <SRLG: 3, 5, 10>” are recorded in the final list 422.

Returning to FIG. 3, in a case where the search order i is less than the total number I−1 (step S7: No), the route search unit 32 increments the search order i (step S8), returns to step S6 and performs search processing in the next section.

### <Search Processing in Section 2>

Following the search processing in the section 1, the route search unit 32 performs the search processing in the section 2 (the via node V6→the end point node D) in the search order 2.

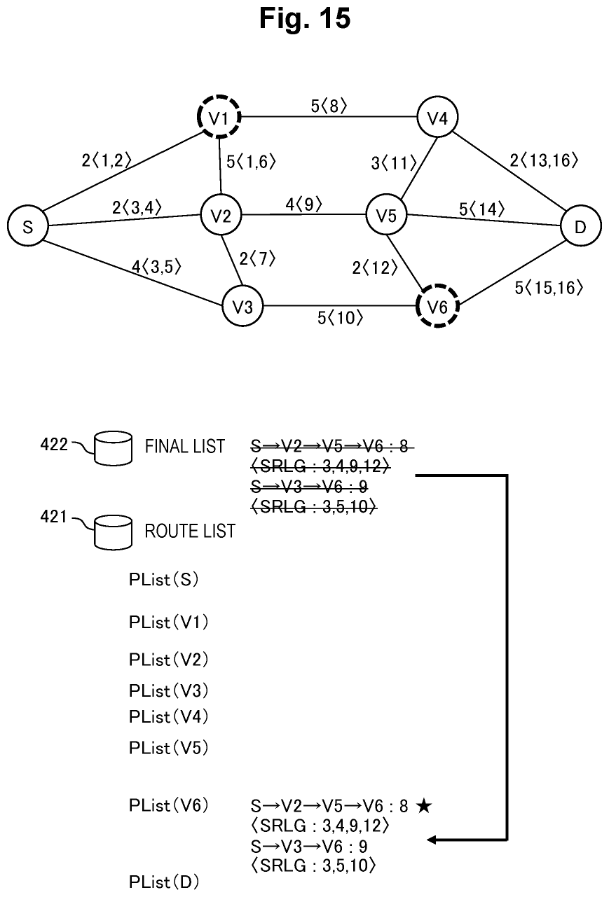

FIGS. 15 to 21 are views for explaining an example of the search processing in the section 2.

### <Search Processing in Section 2—First Time>

As illustrated in FIG. 4, the route search unit 32 selects the node V6 at the start terminal of the section 2 (step S601).

The route search unit 32 refers to the final list 422 of the route information DB 42 (step S602). In the search processing in the section 2, the route created in the search processing in the section 1 is recorded in the final list 422 (step S602: Yes), and thus, the route search unit 32 proceeds to step S611.

The route search unit 32 records the route recorded in the final list 422, in the route list 421 corresponding to the node at the end terminal of the route and deletes the route from the final list 422 (step S611).

In the example of FIG. 15, the route search unit 32 records the route “S→V2→V5→V6:8 <SRLG: 3, 4, 9, 12>” and the route “S→V3→V6:9 <SRLG: 3, 5, 10>” in the final list 422 in PList (V6).

Here, the node at the end terminal of the route recorded in the final list corresponds to the node at the start terminal of the next section. In other words, the route search unit 32 transfers the route created in the search processing in the previous section to the route list 421 of the node at the start terminal of the next section. As a result, the route search unit 32 searches for a route in the next section while avoiding overlapping with the route in the previous section and records the route searched for in the next section in the form of adding the route to the route in the previous section.

The route search unit 32 acquires the shortest route from all the route lists 421 (step S612) and selects the node at the end terminal of the acquired route and deletes the acquired route from the route list 421 (step S613).

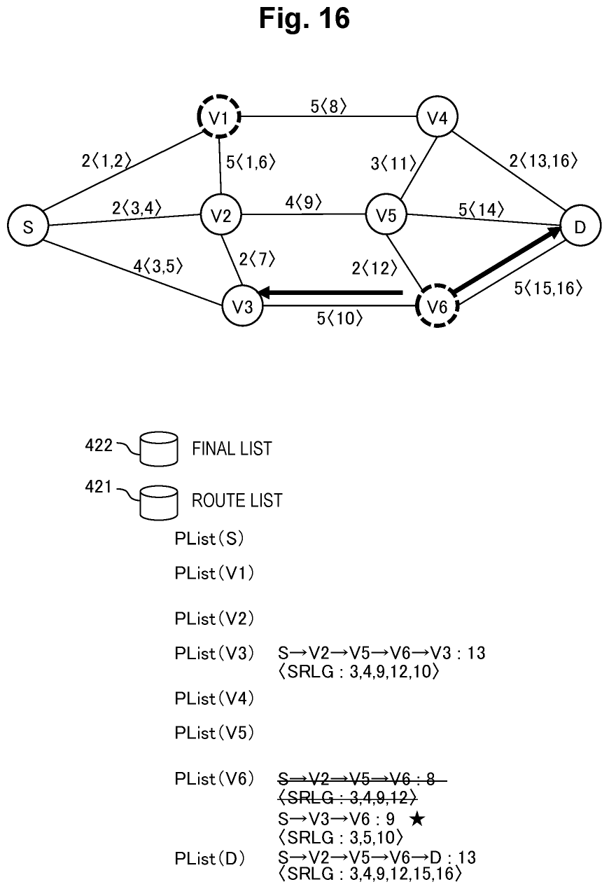

In the example of FIG. 15, the route search unit 32 acquires “S→V2→V5ΔV6:8 <SRLG: 3, 4, 9, 12>” which is the shortest route. As illustrated in FIG. 16, the route search unit 32 selects the node V6 which is the node at the end terminal of the acquired route and deletes the route “S→V2→V5→V6:8 <SRLG: 3, 4, 9, 12>” from PList (V6) (step S613).

Hereinafter, the route search unit 32 performs search processing (steps S603 to S610 in FIG. 4) similar to the search processing in the section 1, and thus, reference to the flowchart in FIG. 4 will be omitted and description will be simplified in the following description.

The route search unit 32 sets the nodes D and V3 adjacent to the selected node V6 as the search targets. Note that the node V5 is not selected because it is included in the route. The route search unit 32 records the route “S→V2→V5→V6→D: 13 <SRLG: 3, 4, 9, 12, 15, 16>” and the route “S→V2→V5→V6→V3:13 <SRLG: 3, 4, 9, 12, 10>” in PList (D) and PList (V3), respectively.

The route search unit 32 acquires “S→V3ΔV6:9”, which is the shortest route, from all the route lists 421. The node D, which is the node at the end terminal of the section 2, is not included in this route, and thus, the route search unit 32 further advances the search.

### <Search Processing in Section 2—Second Time>

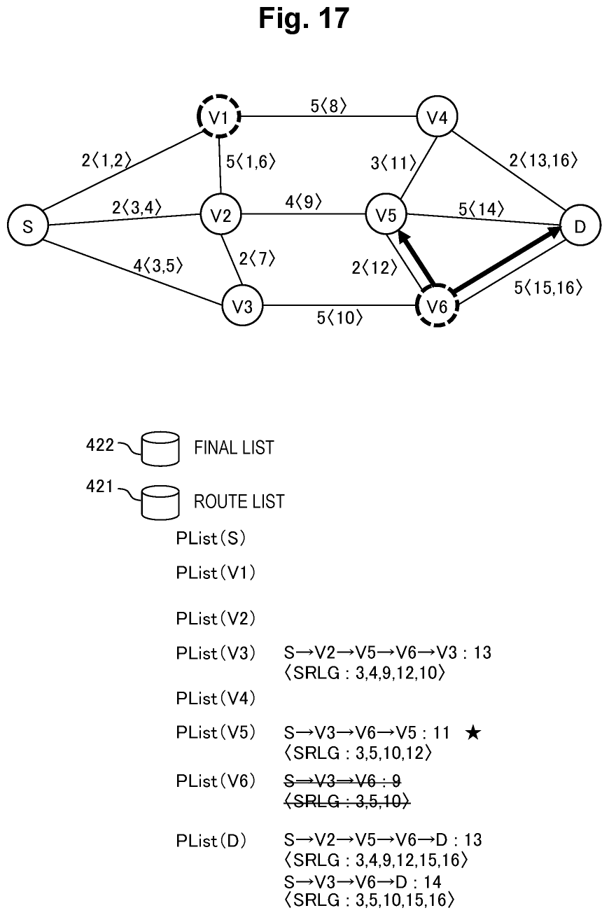

As illustrated in FIG. 17, the node V6 at the end terminal of the acquired route is selected, and the route “S→V3→V6:9 <SRLG: 3, 5, 10>” is deleted from PList (V6). The route search unit 32 sets the adjacent nodes V5 and D of the node V6 as the search targets, records the route “S→V3→V6→V5:11 <SRLG: 3, 5, 10, 12>” in PList (V5) and records the route “S→V3→V6→D: 14 <SRLG: 3, 5, 10, 15, 16>” in PList (D).

The route search unit 32 acquires “S→V3→V6→V5:11”, which is the shortest route, from all the route lists 421.

### <Search Processing in Section 2—Third Time>

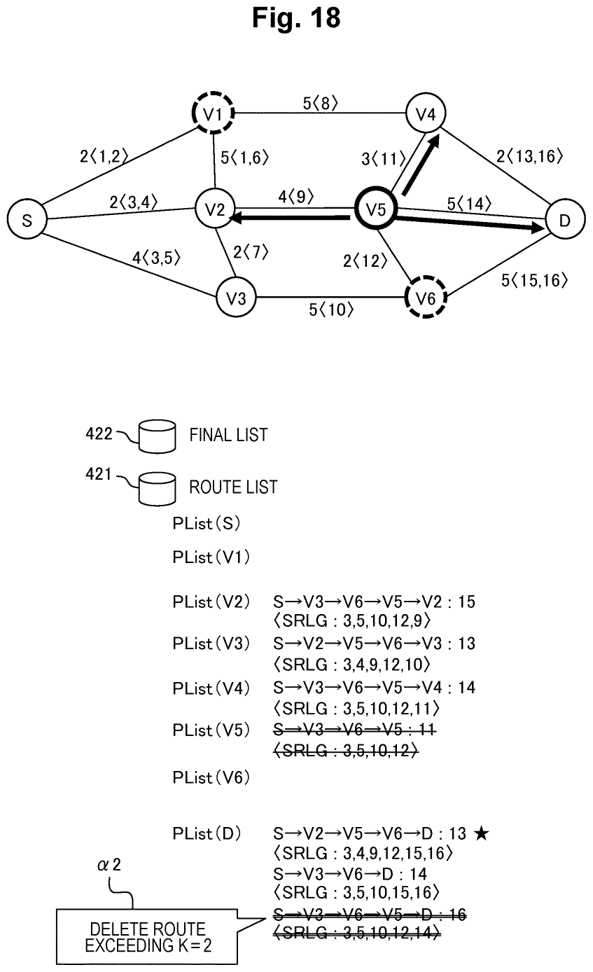

As illustrated in FIG. 18, the route search unit 32 selects the node V5 at the end terminal of the acquired route and deletes the route “S→V3→V6→V5:11 <SRLG: 3, 5, 10, 12>” from PList (V5). The route search unit 32 sets the adjacent nodes V2, V4, and D of the selected node V5 as the search targets and records the route “S→V3→V6→V5→V2:15 <SRLG: 3, 5, 10, 12>” in PList (V2), the route “S→V3→V6→V5→V4:14 <SRLG: 3, 5, 10, 12, 11>” in PList (V4), and the route “S→V3→V6→V5→D: 16 <SRLG: 3, 5, 10, 12, 14>” in PList (D).

The number of routes recorded in PList (D) exceeds K=2, and thus, the route search unit 32 deletes the route “S→V3→V6→V5→D: 16 <SRLG: 3, 5, 10, 12, 14>” from PList (D) (reference sign α2 in FIG. 18).

The route search unit 32 acquires the shortest route “S→V2→V5→V6→D:13” from all the route lists 421.

This route includes the node D that is the end terminal of the section 2.

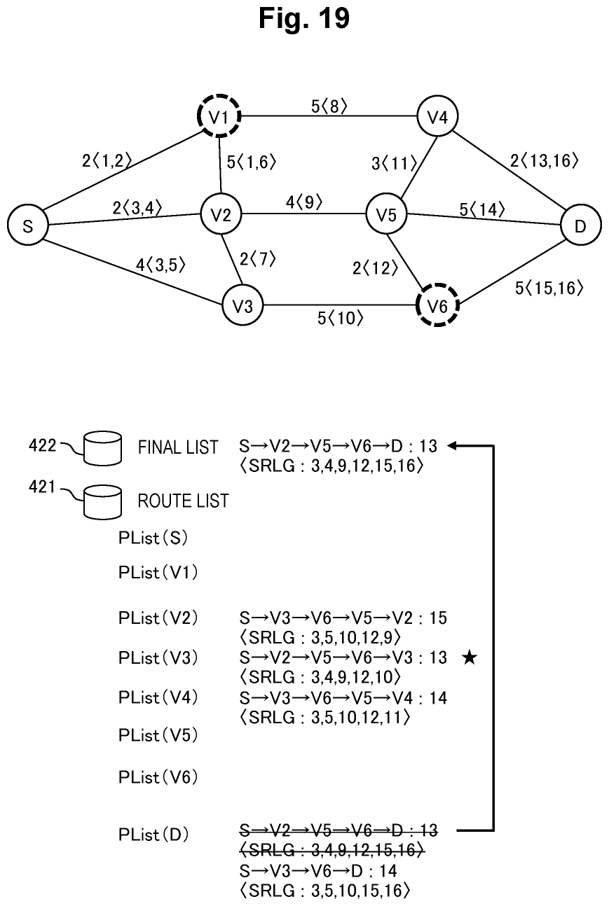

As illustrated in FIG. 19, the route search unit 32 records the route “S→V2→V5→V6→D: 13 <SRLG: 3, 4, 9, 12, 15, 16>” in the final list 422 and deletes the route from PList (D). The route search unit 32 acquires the shortest route “S→V2→V5→V6→V3:13” from all the route lists 421.

### <Search Processing in Section 2—Fourth Time>

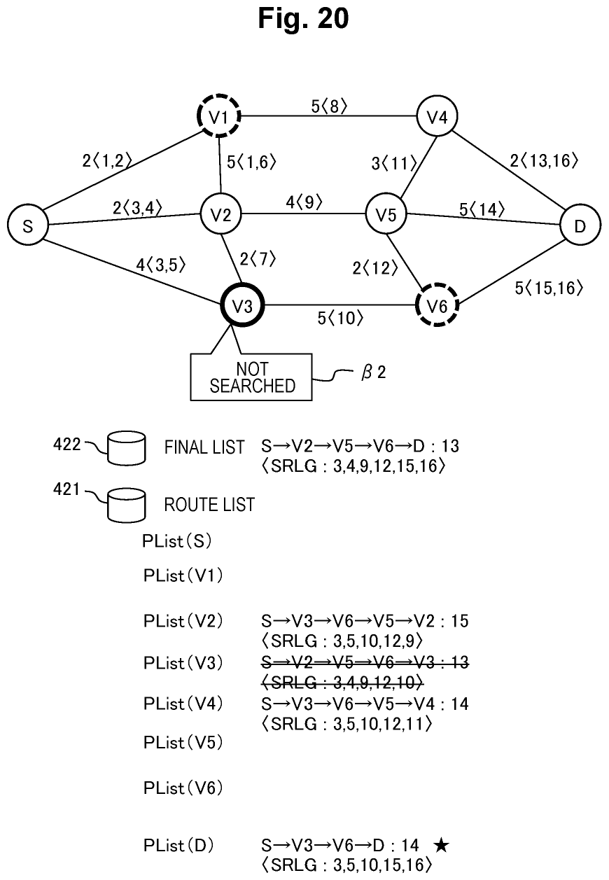

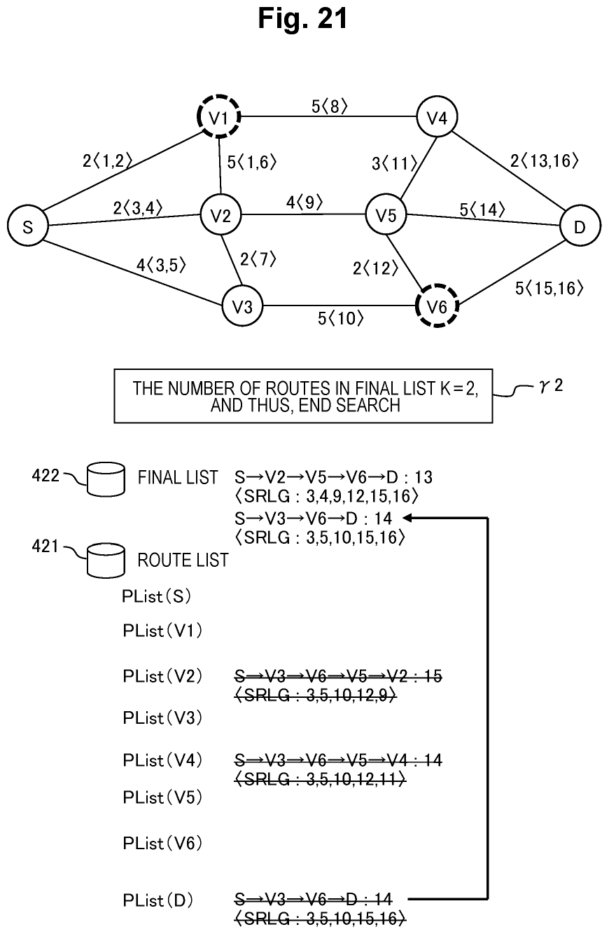

As illustrated in FIG. 20, the route search unit 32 selects the node V3 that is the end terminal of the acquired route and deletes the route “S→V2→V5→V6→V3: 13 <SRLG: 3, 4, 9, 12, 10>” from PList (V3). Both of the nodes V2 and V6 adjacent to the selected node V3 are included in the route “S→V2→V5→V6→V3:13”. Thus, the route search unit 32 neither searches for these nodes nor records routes (reference sign 32 in FIG. 20). The route search unit 32 acquires the shortest route “S→V3→V6→D:14” from all the route lists 421. This route includes the node D that is the end terminal of the section 1. As illustrated in FIG. 21, the route search unit 32 records the route “S→V3→V6→D: 14 <SRLG: 3, 5, 10, 15, 16>” in the final list 422 and deletes the route from PList (D).

The number of routes recorded in the final list 422 is equal to or larger than K=2, and thus, the route search unit 32 deletes all the routes recorded in the route list 421 of each node and ends the search processing in the section 2 (reference numeral γ2 in FIG. 21). As a result of the search processing in the section 2, two routes “S→V2→V5→V6→D: 13 <SRLG: 3, 4, 9, 12, 15, 16>” and “S→V3→V6→D: 14 <SRLG: 3, 5, 10, 15, 16>” are recorded in the final list 422.

### <Search Processing in Section 3>

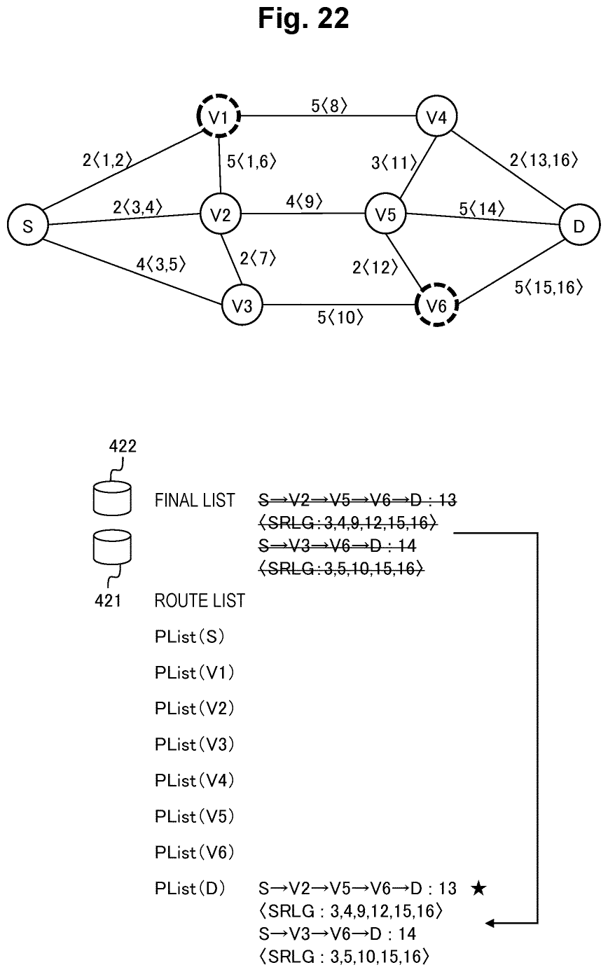

FIGS. 22 to 31 are views for explaining an example of the search processing in the section 3.

The route search unit 32 performs the processing of steps S7 to S8 in FIG. 3 and proceeds to the search processing in the section 3 (the end point node D→the via node V1) in the search order 3.

<Search Processing in Section 3—First Time>

As illustrated in FIG. 22, the route search unit 32 records the route “S→V2→V5→V6→D: 13 <SRLG: 3, 4, 9, 12, 15, 16>” and the route “S→V3→V6→D: 14 <SRLG: 3, 5, 10, 15, 16>” recorded in the final list 422 in PList (D) and deletes the routes from the final list 422.

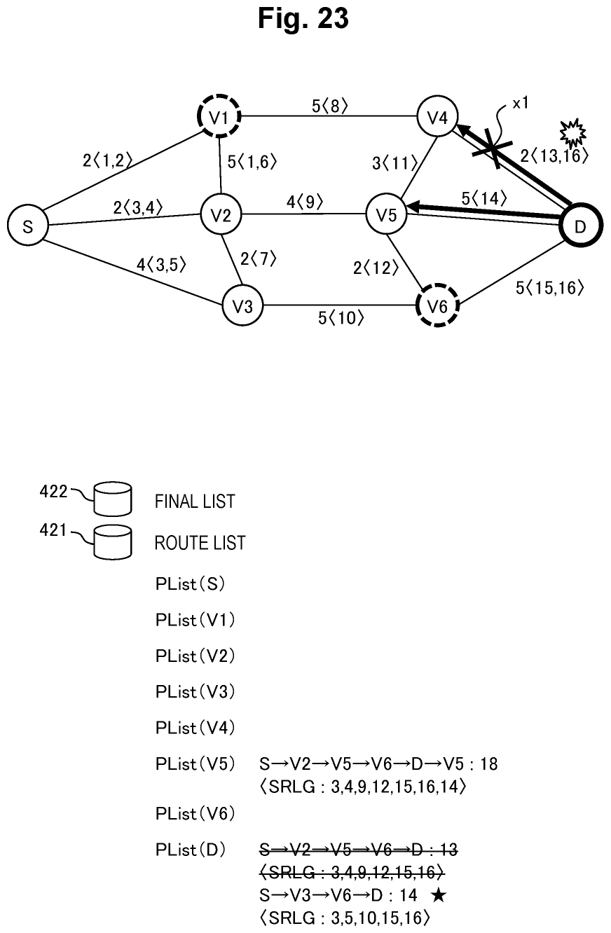

The route search unit 32 acquires the shortest route “S→V2→V5→V6→D:13”. As illustrated in FIG. 23, the route search unit 32 selects the node D that is the end terminal of the acquired route and deletes the route “S→V2→V5→V6→D: 13 <SRLG: 3, 4, 9, 12, 15, 16>” from PList (D).

Here, the nodes adjacent to the selected node D are the nodes V4 and V5. However, the route “S→V2→V5→V6→D→V4:15 <SRLG: 3, 4, 9, 12, 15, 16, 13, 16>” is not added to PList (V4) (reference numeral x1 in FIG. 23).

This is because <SRLG: 16>, which is the SRLG information, overlaps in the route of a different system (0-system route).

The route search unit 32 records the route “S→V2→V5→V6→D→V5:18 <SRLG: 3, 4, 9, 12, 15, 16, 14>” in PList (V5). Here, although the node V5 is redundantly selected, the node V5 has the attribute information that allows node overlapping between other systems (here, between the 0-system route and the 1-system route), and SRLG information does not overlap between other systems.

Therefore, V5 is set as the search target.

Then, the route search unit 32 acquires “S→V3→V6→D:14”, which is the shortest route, from all the route lists 421.

### <Search Processing in Section 3—Second Time>

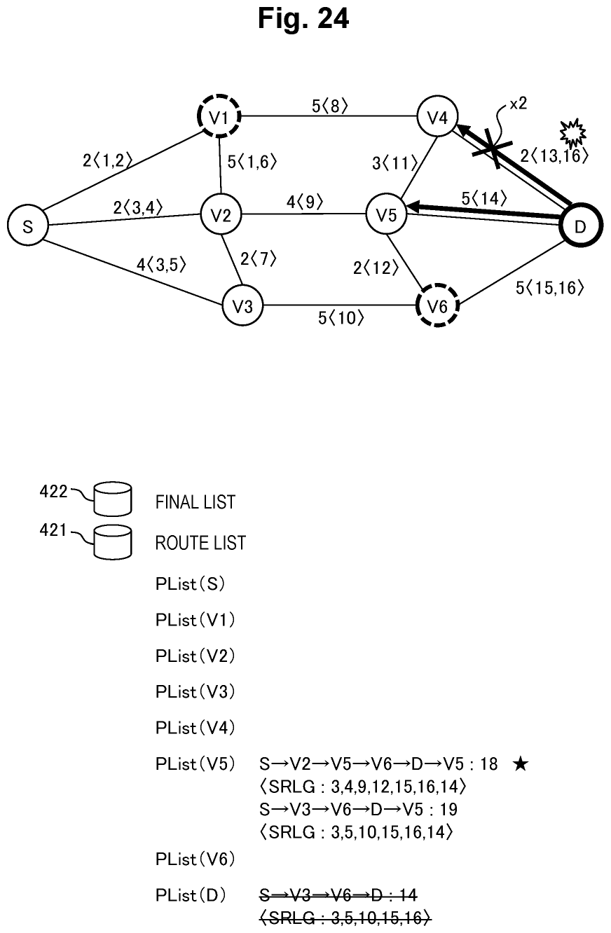

As illustrated in FIG. 24, the route search unit 32 selects the node D that is the end terminal of the acquired route and deletes the route “S→V3→V6→D:14 <SRLG: 3, 5, 10, 15, 16>” from PList (D).

Here, the nodes adjacent to the selected node D are the nodes V4 and V5. However, the route “S→V3→V6→D→V4:16 <SRLG: 3, 5, 10, 15, 16, 13, 16>” is not added to PList (V4) (reference numeral x2 in FIG. 24). This is because <SRLG: 16>, which is the SRLG information, overlaps in the route of a different system (0-system route).

The route search unit 32 records the route “S→V3→V6→D→V5:19 <SRLG: 3, 5, 10, 15, 16, 14>” in PList (V5).

Then, the route search unit 32 acquires a route “S→V2→V5→V6→D→V5:18” which is the shortest route from all the route lists 421. The node V1 that is the node at the end terminal of the section 3 is not included in this route, and thus, the route search unit 32 further advances the search.

### <Search Processing in Section 3—Third Time>

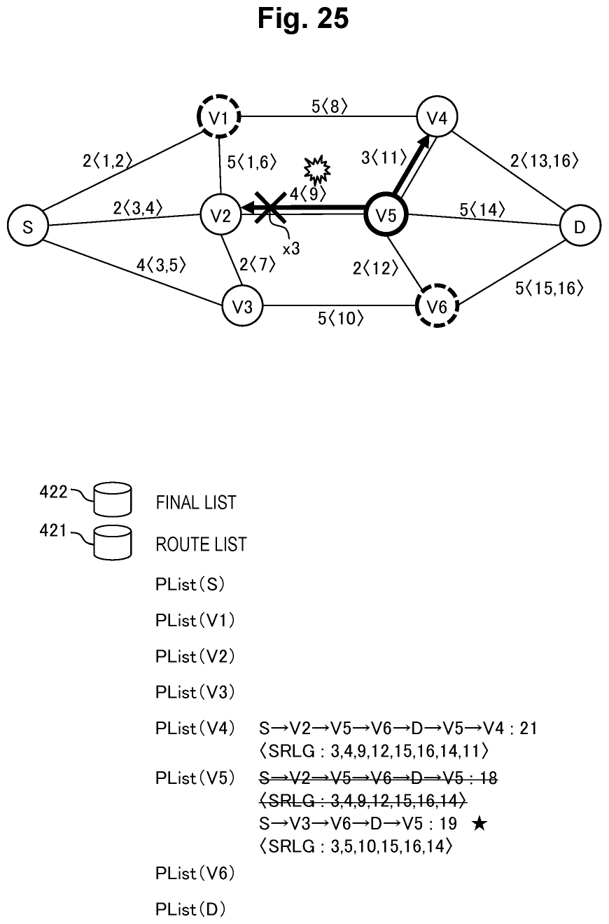

As illustrated in FIG. 25, the node V5 at the end terminal of the acquired route is selected, and the route “S→V2→V5→V6→D→V5:18 <SRLG: 3, 4, 9, 12, 15, 16, 14>” is deleted from PList (V5).

Here, the nodes adjacent to the selected node V5 are the nodes V2 and V4. However, the route “S→V2→V5→V6→D→V5→V2→22 <SRLG: 3, 4, 9, 12, 15, 16, 14, 9>” is not added to PList (V2) (reference numeral x3 in FIG. 25). This is because <SRLG: 9> that is the SRLG information overlaps in the route of a different system (0-system route).

The route search unit 32 records the route “S→V2→V5→V6→D→V5→V4:21 <SRLG: 3, 4, 9, 12, 15, 16, 14, 11>” in PList (V4).

Then, the route search unit 32 acquires “S→V3→V6→D→V5:19”, which is the shortest route, from all the route lists 421. The node V1 that is the node at the end terminal of the section 3 is not included in this route, and thus, the route search unit 32 further advances the search.

### <Search Processing in Section 3—Fourth Time>

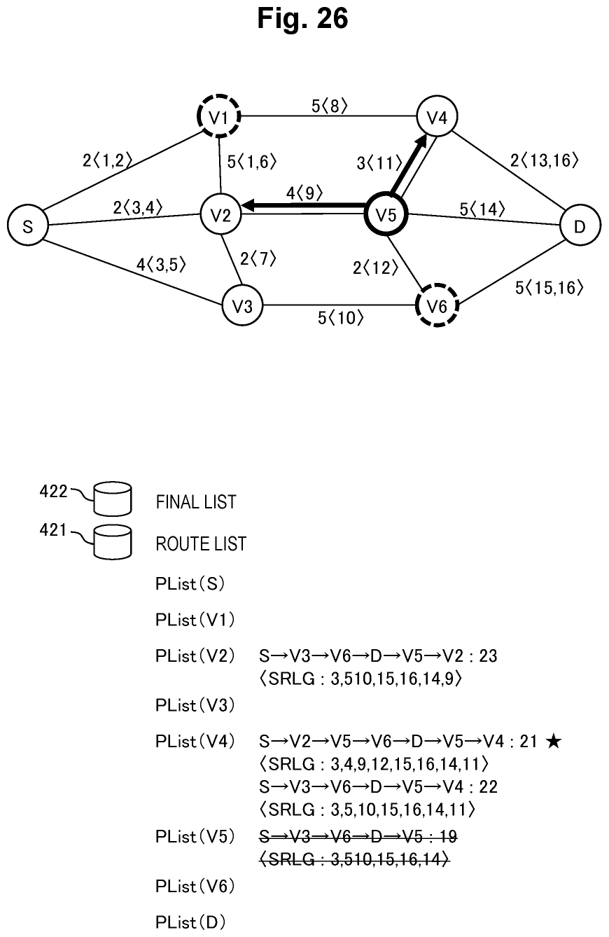

As illustrated in FIG. 26, the node V5 at the end terminal of the acquired route is selected, and the route “S→V3→V6→D→V5:19 <SRLG: 3, 5, 10, 15, 16, 14>” is deleted from PList (V5).

The route search unit 32 sets the adjacent nodes V2 and V4 of the selected node V5 as the search targets and records a route “S→V3→V6→D→V5→V2:23 <SRLG: 3, 5, 10, 15, 16, 14, 9>” in PList (V2) and a route “S→V3→V6→D→V5→V4:22 <SRLG: 3, 5, 10, 15, 16, 14, 11>” in PList (V4).

The route search unit 32 acquires “S→V2→V5→V6→D→V5→V4:21” which is the shortest route from all the route lists 421. The node V1 that is the node at the end terminal of the section 3 is not included in this route, and thus, the route search unit 32 further advances the search.

### <Search Processing in Section 3—Fifth Time>

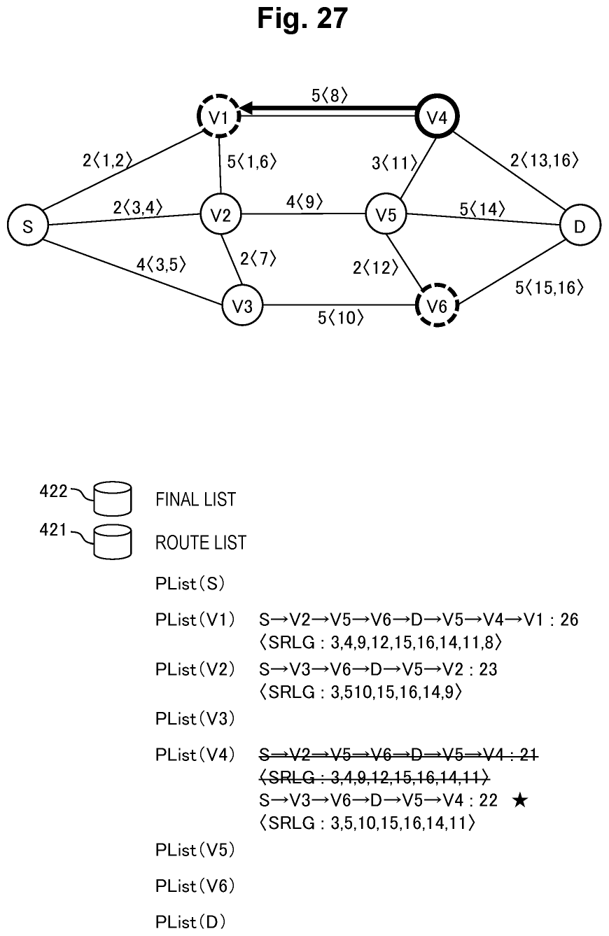

As illustrated in FIG. 27, the node V4 at the end terminal of the acquired route is selected, and the route “S→V2→V5→V6→D→V5→V4:21 <SRLG: 3, 4, 9, 12, 15, 16, 14, 11>” is deleted from PList (V4). The nodes adjacent to the selected node V4 are the nodes V1 and V5, but the route “S→V2→V5→V6→D→V5→V4:21” already includes the node V5 in the 1-system route that is the same system. Thus, the route search unit 32 excludes the node V5 and sets the node V1 as the search target. The route search unit 32 records the route “S→V2→V5→V6→D→V5→V4→V1:26 <SRLG: 3, 4, 9, 12, 15, 16, 14, 11, 8>” in PList (V1).

The route search unit 32 acquires “S→V3→V6→D→V5→V4:22” which is the shortest route from all the route lists 421. The node V1 that is the node at the end terminal of the section 3 is not included in this route, and thus, the route search unit 32 further advances the search.

### <Search Processing in Section 3—Sixth Time>

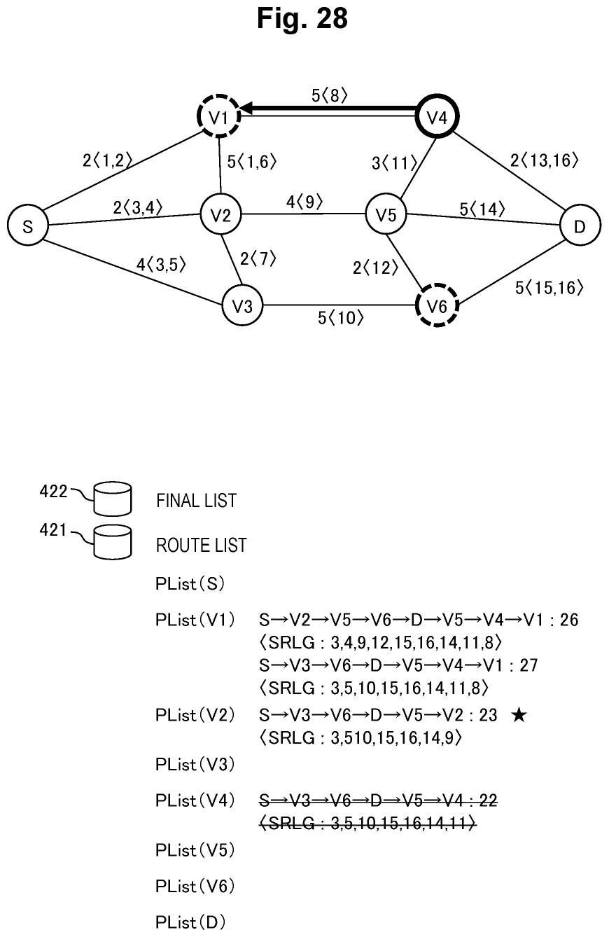

As illustrated in FIG. 28, the node V4 at the end terminal of the acquired route is selected, and the route “S→V3→V6→D→V5→V4:22 <SRLG: 3, 5, 10, 15, 16, 14, 11>” is deleted from PList (V4). The nodes adjacent to the selected node V4 are the nodes V1 and V5, but the route “S→V3→V6→D→V5→V4:22” already includes the node V5 in the 1-system route. Thus, the route search unit 32 excludes the node V5 and sets the node V1 as the search target. The route search unit 32 records the route “S→V3→V6→D→V5→V4→V1:27 <SRLG: 3, 5, 10, 15, 16, 14, 11, 8>” in PList (V1).

The route search unit 32 acquires “S→V3→V6→D→V5→V2: 23” which is the shortest route from all the route lists 421. The node V1 that is the node at the end terminal of the section 3 is not included in this route, and thus, the route search unit 32 further advances the search.

### <Search Processing in Section 3—Seventh Time>

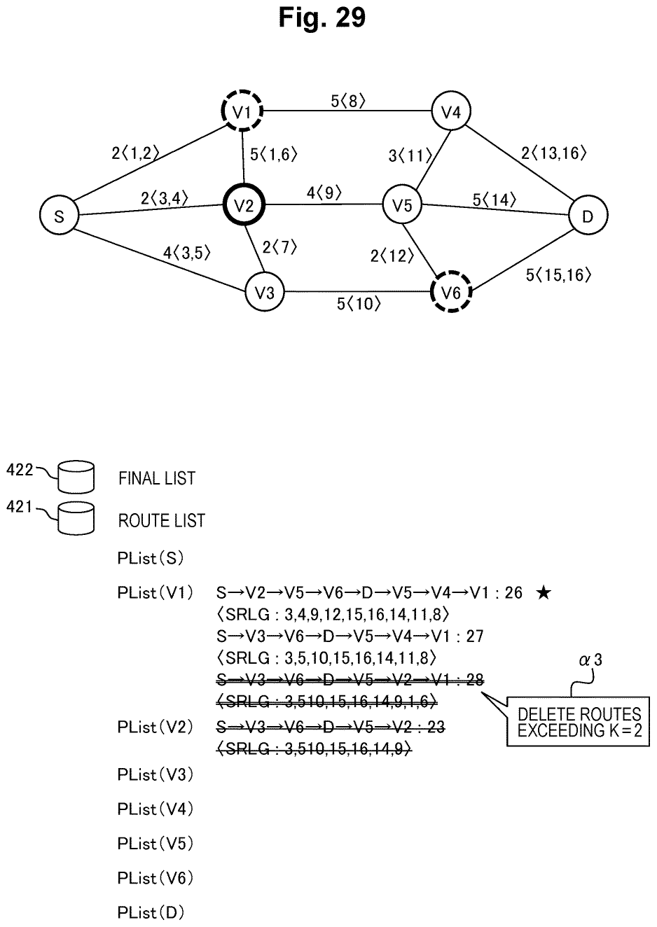

As illustrated in FIG. 29, the node V2 at the end terminal of the acquired route is selected, and the route “S→V3→V6→D→V5→V2:23 <SRLG: 3, 5, 10, 15, 16, 14, 9>” is deleted from PList (V2).

The nodes adjacent to the selected node V2 are the nodes V1 and S, but the node S is an end point node included in another section, and thus, the node S is excluded from the search targets. In addition, the route search unit 32 does not record the route “S→V3→V6→D→V5→V2→V1:28 <SRLG: 3, 5, 10, 15, 16, 14, 9, 1, 6>” in PList (V1). Here, if the route is recorded in PList (V1), the number of routes becomes three, and thus exceeds the number K=2 specified in the search condition. Thus, the route search unit 32 deletes one route with high cost from the two routes recorded in PList (V1) and the route to be recorded in PList (V1) (reference numeral α3 in FIG. 29).

Here, the route “S→V3→V6→D→V5→V2→V1:28” to be recorded in PList (V1) has the highest cost among the three routes, and thus, the route is not recorded.

The route search unit 32 acquires “S→V2→V5→V6→D→V5→V4→V1:26” which is the shortest route from all the route lists 421. This route includes the node V1 that is the end terminal of the section 3.

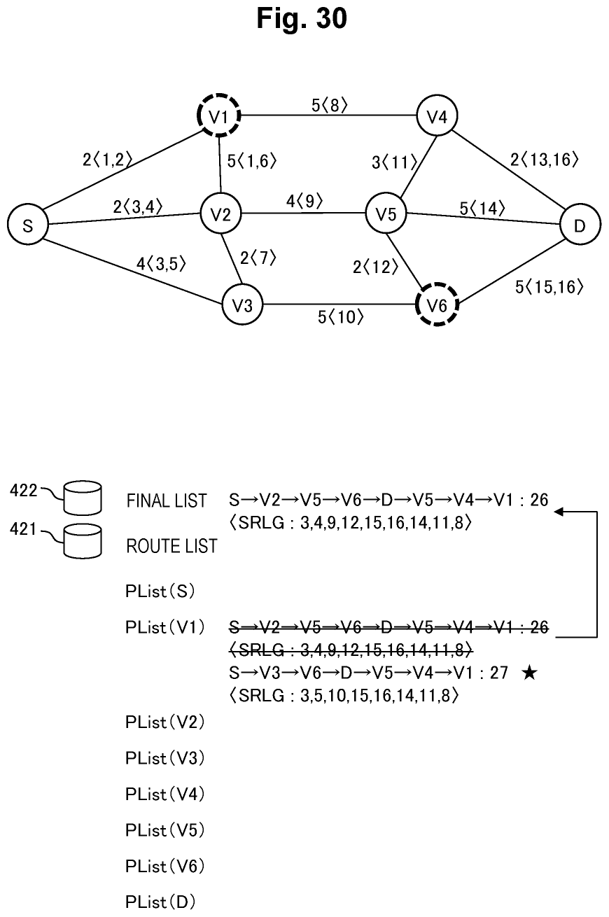

As illustrated in FIG. 30, the route search unit 32 deletes the route “S→V2→V5→V6→D→V5→V4→V1:26 <SRLG: 3, 4, 9, 12, 15, 16, 14, 11, 8>” from PList (V1) and records the route in the final list 422.

Here, the number of routes recorded in the final list 422 is 1, which is less than K=2 (step S609 in FIG. 4: No). Thus, the route search unit 32 returns to step S605 and acquires “S→V3→V6→D→V5→V4→V1:27”, which is the shortest route, from all the route lists 421. This route includes the node V1 that is the end terminal of the section 3.

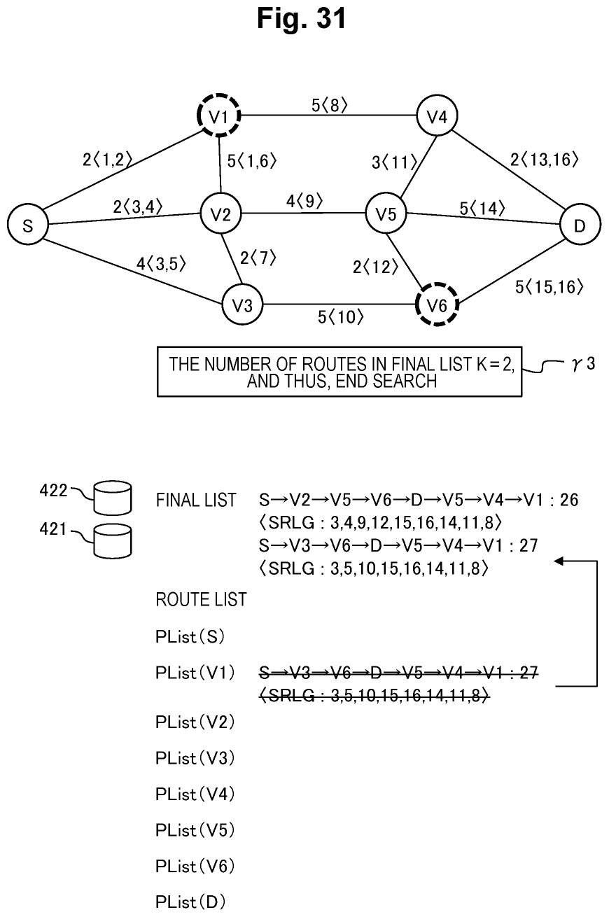

As illustrated in FIG. 31, the route search unit 32 deletes the route “S→V3→V6→D→V5→V4→V1:27 <SRLG: 3, 5, 10, 15, 16, 14, 11, 8>” from PList (V1) and records the route in the final list 422.

Here, the number of routes recorded in the final list 422 is K=2 (step S609 in FIG. 4: Yes), and thus, the route search unit 32 deletes all the routes recorded in the route list 421 corresponding to each node (step S609) (in FIG. 31, there is no route to be deleted) and ends the search processing in the section 3 (reference sign γ3 in FIG. 31).

In the final list, two routes of the route “S→V2→V5→V6→D→V5→V4→V1:26 <SRLG: 3, 4, 9, 12, 15, 16, 14, 11, 8>” and the route “S→V3→V6→D→V5→V4→V1:27 <SRLG: 3, 5, 10, 15, 16, 14, 11, 8>” are recorded as the search result of the section 3.

Returning to FIG. 3, in a case where the search order i satisfies the total number I−1 (step S7: Yes), the route search unit 32 performs search processing of the last search section (step S9). Here, the search order i=3 and the total number I−1 =4−1=3, and thus, the condition of step S7 is satisfied, and the search processing in the section 4 in step S9 is performed.

### <Search Processing in Section 4>

Following the search processing in the section 3, the route search unit 32 performs the search processing in the section 4 (the via node V1→the start point node S) in the search order 4.

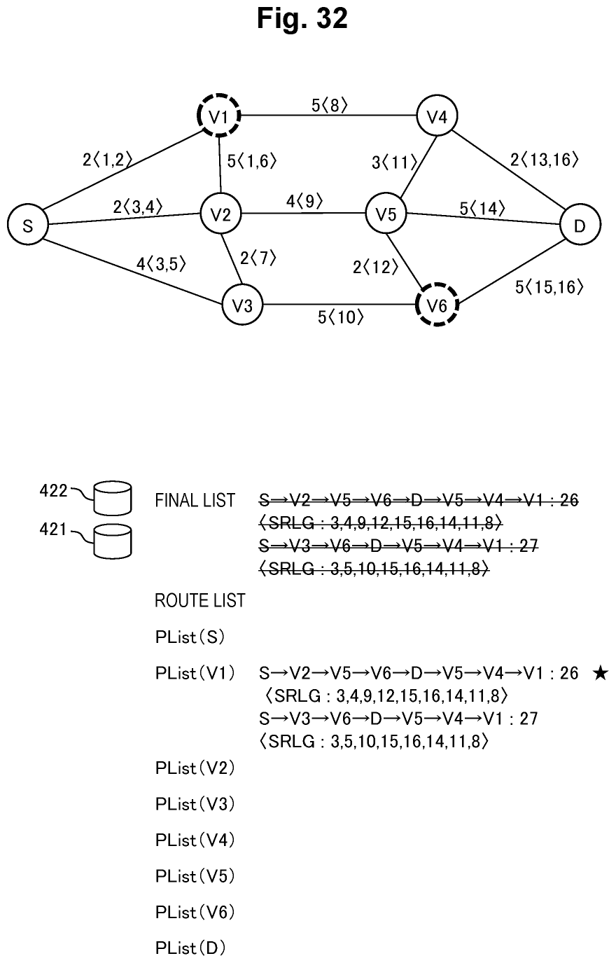

FIGS. 32 to 36 are views for explaining an example of the search processing in the section 4.

The route search unit 32 executes the search processing of the last search section in step S9 in FIG. 3 as processing similar to steps S601 to S613 in FIG. 4.

However, in step S609, the route search unit ends the processing in a case where the number of routes in the final list becomes equal to or larger than L. L is “the number L of combinations of the 0-system route and the 1-system route to be output”, and is designated with an integer equal to or greater than 1 and equal to or less than K in the search condition as described above. As a result, while searching for K shortest route candidates in the search processing in the section 1 to the section 3, the route search unit 32 can output a route finally narrowed down to L in the section 4 that is the last section. The route created in the section 4 that is the last section becomes the route of the entire search section, and the combination of the 0-system route and the 1-system route is created by dividing the route.

### <Search Processing in Section 4—First Time>

As illustrated in FIG. 32, the route search unit 32 records the route “S→V2→V5→V6→D→V5→V4→V1:26 <SRLG: 3, 4, 9, 12, 15, 16, 14, 11, 8>” and the route “S→V3→V6→D→V5→V4→V1:27 <SRLG: 3, 5, 10, 15, 16, 14, 11, 8>” recorded in the final list 422 in PList (V1) and deletes them from the final list 422.

The route search unit 32 acquires the shortest route “S→V2→V5→V6→D→V5→V4→V1:26”.

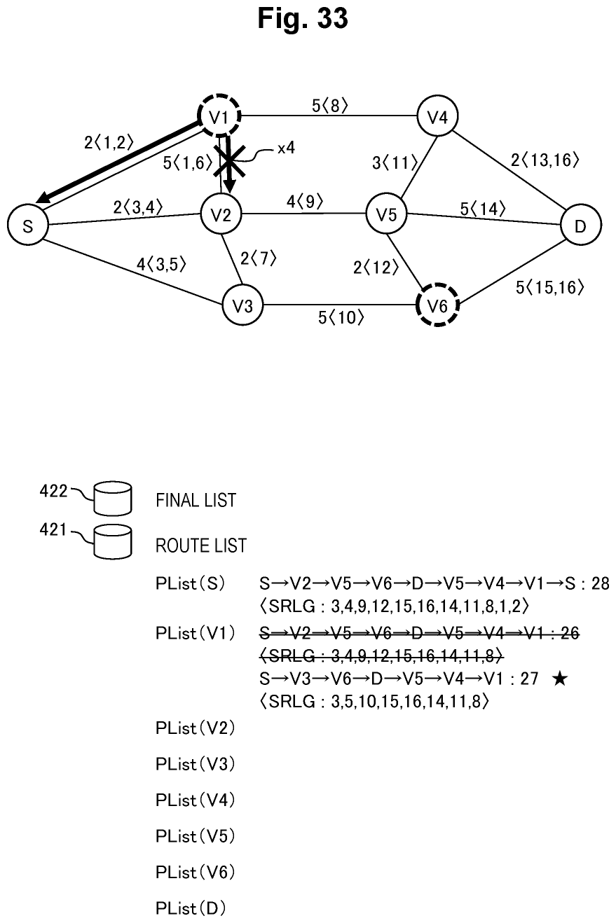

As illustrated in FIG. 33, the route search unit 32 selects the node V1 at the end terminal of the acquired route and deletes the route “S→V2→V5→V6→D→V5→V4→V1:26 <SRLG: 3, 4, 9, 12, 15, 16, 14, 11, 8>” from PList (V1).

Here, the nodes adjacent to the selected node V1 are the nodes V2 and S. However, the route “S→V2→V5→V6→D→V5→V4→V1→V2:31 <SRLG: 3, 4, 9, 12, 15, 16, 14, 11, 8, 1, 6>” is not added to PList (V2) (reference numeral x4 in FIG. 33). This is because the node V2 overlapping in the route is set with the attribute information that does not allow node overlapping between different systems (here, between the 0-system route and the 1-system route).

The route search unit 32 records the route “S→V2→V5→V6→D→V5→V4→V1>S:28 <SRLG: 3, 4, 9, 12, 15, 16, 14, 11, 8, 1, 2>” in PList(S).

Then, the route search unit 32 acquires “S→V3→V6→D→V5→V4→V1:27” which is the shortest route from all the route lists 421.

### <Search Processing in Section 4—Second Time>

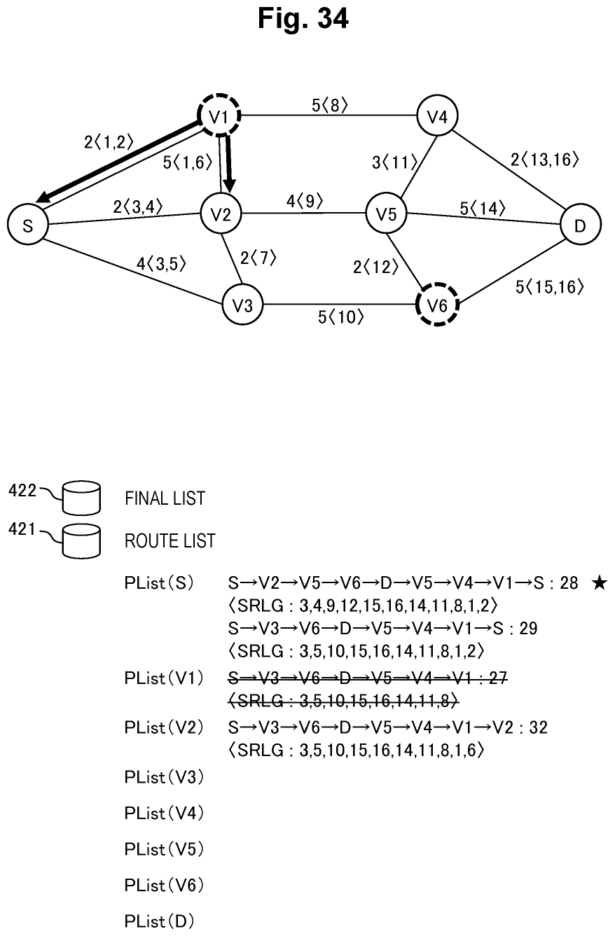

As illustrated in FIG. 34, the route search unit 32 selects the node V1 at the end terminal of the acquired route and deletes the route “S→V3→V6→D→V5→V4→V1:27 <SRLG: 3, 5, 10, 15, 16, 14, 11, 8>” from PList (V1). The route search unit 32 sets the adjacent nodes V2 and S of the selected node V1 as the search targets and records the route “S→V3→V6→D→V5→V4→V1:32 <SRLG: 3, 5, 10, 15, 16, 14, 11, 8, 1, 6>” in PList (V2) and the route “S→V3→V6→D→V5→V4→V1→S:29 <SRLG: 3, 5, 10, 15, 16, 14, 11, 8, 1, 2>” in PList (S).

The route search unit 32 acquires “S→V2→V5→V6→D→V5→V4→V1→S:28”, which is the shortest route, from all the route lists 421. This route includes the node S that is the end terminal of the section 4.

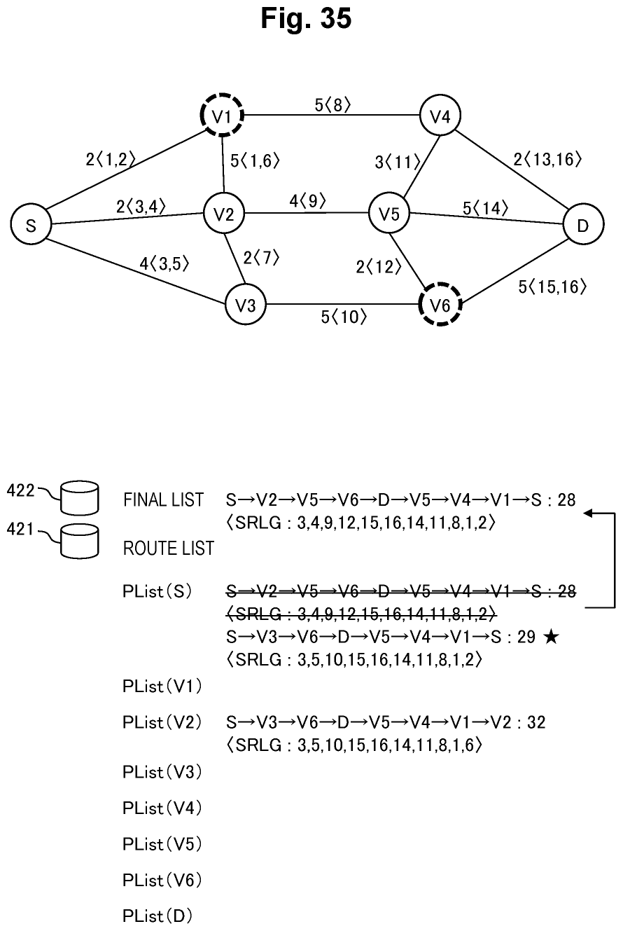

As illustrated in FIG. 35, the route search unit 32 deletes the route “S→V2→V5→V6→D→V5→V4→V1→S:28 <SRLG: 3, 4, 9, 12, 15, 16, 14, 11, 8, 1, 2>” from PList (S) and records the route in the final list 422.

Here, the number of routes recorded in the final list 422 is 1, and L (the number of combinations of the 0-system route and the 1-system route to be output)=2 is not satisfied (step S609 in FIG. 4: No). Thus, the route search unit 32 returns to step S605 and acquires “S→V3→V6→D→V5→V4→V1→S:29”, which is the shortest route, from all the route lists 421. This route includes the node S that is the end terminal of the section 4.

Note that, if L (the number of combinations of the 0-system route and the 1-system route to be output)=1 is set as the search condition, the search processing in the section 4 is finished at the time point when one route is recorded in the final list 422 after deletion from the route list 421.

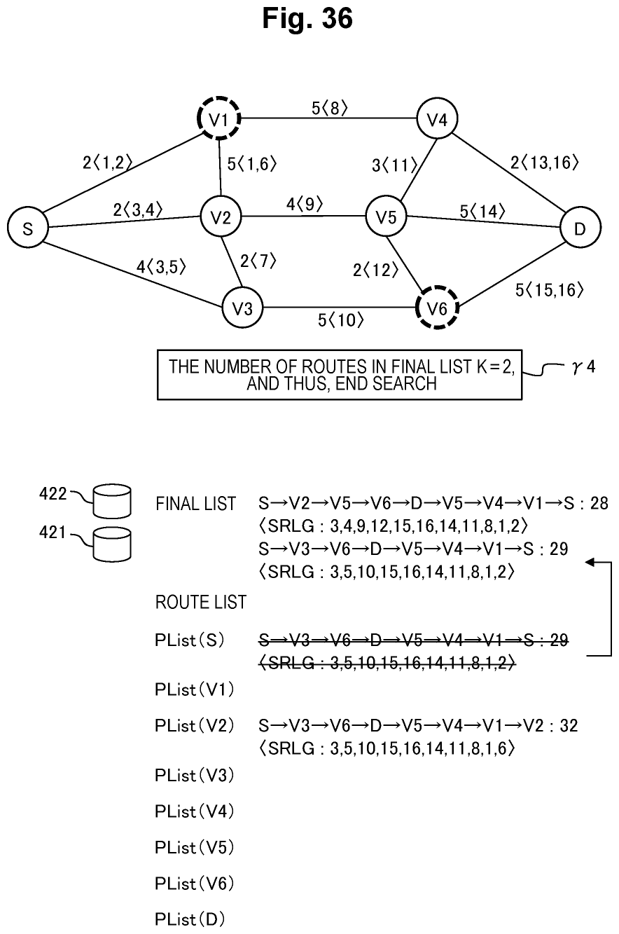

As illustrated in FIG. 36, the route search unit 32 deletes the route “S→V3→V6→D→V5→V4→V1→S:29 <SRLG: 3, 5, 10, 15, 16, 14, 11, 8, 1, 2>” from PList (S) and records the route in the final list 422.

Here, the number of routes recorded in the final list 422 is L=2 (step S609 in FIG. 4: Yes), and thus, the route search unit 32 deletes all the routes recorded in the route list 421 corresponding to each node (step S609) and ends the search processing in the section 4 (reference sign γ4 in FIG. 36).

In the final list, two routes of the route “S→V2→V5→V6→D→V5→V4→V1→S:28 <SRLG: 3, 4, 9, 12, 15, 16, 14, 11, 8, 1, 2>” and the route “S→V3→V6→D→V5→V4→V1→S:29 <SRLG: 3, 5, 10, 15, 16, 14, 11, 8, 1, 2>” are recorded as the search result of the section 4.

Then, returning to step S10 in FIG. 3, the route search unit 32 acquires the route of the entire search section recorded in the final list 422, divides the route at the end point node which is the turning point and outputs the 0-system route and the 1-system route via the input/output unit 2.

Here, in a case where a plurality of routes is recorded in the final list 422, a plurality of combinations of the 0-system route and the 1-system route is created.

The route search unit 32 acquires the route recorded in the final list, divides the acquired route at the node N (end point node D) which is the turning point and outputs the combination of the 0-system route and the 1-system route.

In the example of FIG. 36, in a case where the first route “S→V2→V5→V6→D→V5→V4→V1→S:28” is divided at the end point node D, the 0-system route and the 1-system route are as follows.
0-system route: S→V2→V5→V6→D (cost 13)
1-system route: S→V1→V4→V5→D (cost 15)

In a case where the second route “S→V3→V6→D→V5→V4→V1→S:29” is divided at the end point node D, the 0-system route and the 1-system route are as follows.
0-system route: S→V3→V6→D (cost 14)
1-system route: S→V1→V4→V5→D (cost 15)

In any combination, the SRLG information does not overlap in the 0-system route and the 1-system route. In addition, in the first route, a node (node V5) for which node overlapping is allowed in the attribute information of the node overlaps in the 0-system route and the 1-system route. The cost of the first 0-system route is “13”, and the cost of the 1-system route is “15”. The cost of the second 0-system route is “14”, and the cost of the 1-system route is “15”. Thus, bias of the cost bias of the 0-system route and the 1-system route is not large.

As described above, in the route search device 1 of the present embodiment, it is possible to create a plurality of routes which avoids overlapping of the SRLG in each route and for which the cost is balanced.

### <Hardware Configuration>

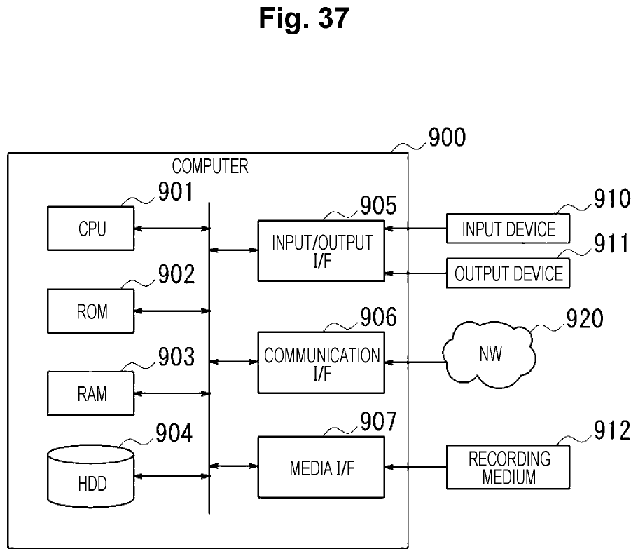

The route search device 1 according to the present embodiment is implemented by a computer 900 as illustrated in FIG. 37, for example.

FIG. 37 is a hardware configuration diagram illustrating an example of the computer 900 that implements functions of the route search device 1 according to the present embodiment. The computer 900 includes a central processing unit (CPU) 901, a read only memory (ROM) 902, a RAM 903, a hard disk drive (HDD) 904, an input/output interface (I/F) 905, a communication I/F 906, and a media I/F 907.

The CPU 901 operates based on a program (route search program) stored in the ROM 902 or the HDD 904 and performs control by the control unit 3 of the route search device 1 illustrated in FIG. 2. The ROM 902 stores a boot program to be executed by the CPU 901 when the computer 900 is started, a program related to hardware of the computer 900, and the like.

The CPU 901 controls, via the input/output I/F 905, an input device 910 such as a mouse and a keyboard, and an output device 911 such as a display. The CPU 901 acquires data from the input device 910 and outputs generated data to the output device 911 via the input/output I/F 905. Note that a graphics processing unit (GPU), or the like, may be used as a processor together with the CPU 901.

The HDD 904 stores a program to be executed by the CPU 901, data to be used by the program, and the like. The communication I/F 906 receives data from another device such as the management device 9 (see FIG. 1) via a communication network (for example, a network (NW) 920), outputs the data to the CPU 901, and transmits data generated by the CPU 901 to another device via the communication network.

The media I/F 907 reads a program or data stored in a recording medium 912, and outputs the program or data to the CPU 901 via the RAM 903. The CPU 901 loads a program related to target processing from the recording medium 912 into the RAM 903 via the media I/F 907 and executes the loaded program. The recording medium 912 is an optical recording medium such as a digital versatile disc (DVD) or a phase change rewritable disk (PD), a magneto optical recording medium such as a magneto optical disk (MO), a magnetic recording medium, a conductor memory tape medium, a semiconductor memory, or the like.

In a case where the computer 900 functions as the route search device 1 according to the present embodiment, for example, the CPU 901 of the computer 900 implements the functions of the route search device 1 by executing the program loaded on the RAM 903. Further, the HDD 904 stores data in the RAM 903. The CPU 901 reads a program related to target processing from the recording medium 912 and executes the program. Additionally, the CPU 901 may read the program related to the target processing from other devices via the communication network (NW 920).

Although FIG. 1 illustrates an example in which the route search device 1 is provided independently of the management device 9, the route search device 1 can also be configured as one of the functions of the management device 9. In this case, the computer 900 may function as the management device 9.

### <<Modification 1>>

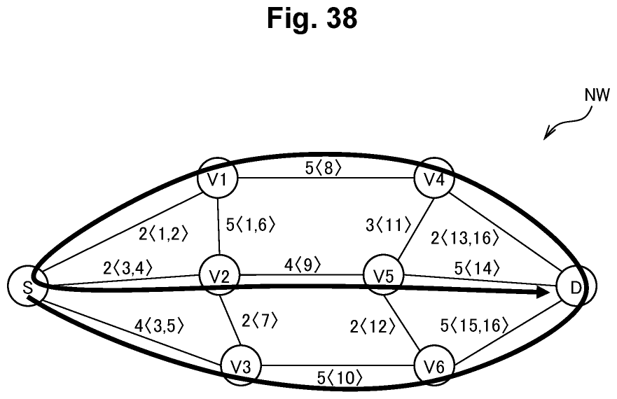

FIG. 38 is a view for explaining outline of processing of the route search device 1 according to Modification 1.

In the embodiment described above, an example of creating two routes of the 0-system route (main route) and one 1-system route (redundant route) has been described, but the redundant route is not limited to one, and for example, two or more redundant routes may be created. In this case, the end terminal of the search section can be extended according to the number of additional routes to be added to the 0-system route and the 1-system route.

FIG. 38 illustrates, as an example, a case where a 2-system route is created in addition to the 0-system route and the 1-system route. The section division unit 31 sets the search section from the start point node S, going through the end point node D, and further going through the start point node S, and reaching the end point node D. In a case where the via node is designated to each of the 0-system route, the 1-system route, and the 2-system route, the section division unit 31 arranges the each via node between the start point node and the end point node.

Similarly to the above-described embodiment, the section division unit 31 divides the set search section with the start point node S, the via nodes, and the end point node D as terminal points. The route search unit 32 performs search processing similar to the embodiment for each divided section.

Note that, in Modification 1, the end point node D overlaps with the start terminal of the section corresponding to the 1-system route, as the end terminal of the section corresponding to the 2-system route. Thus, in Modification 1, the end point node D is exceptionally allowed to overlap in the route, in addition to the start point node S.

In FIG. 38, an example of a route of the search section created by the search processing of the route search unit 32 is indicated by the arrow. In Modification 1, a so-called one-stroke route connecting the 0-system route to the 1-system route and to the 2-system route is created as the route of the search section. The route search unit 32 creates three routes of the 0-system route, the 1-system route, and the 2-system route by dividing the route of the search section created in this manner at the start point node S and the end point node D.

In a case of creating additional routes after a 3-system route, the section division unit 31 further extends the end terminal of the search section to the start point node S or the end point node D according to the number of additional routes.

### <<Modification 2>>

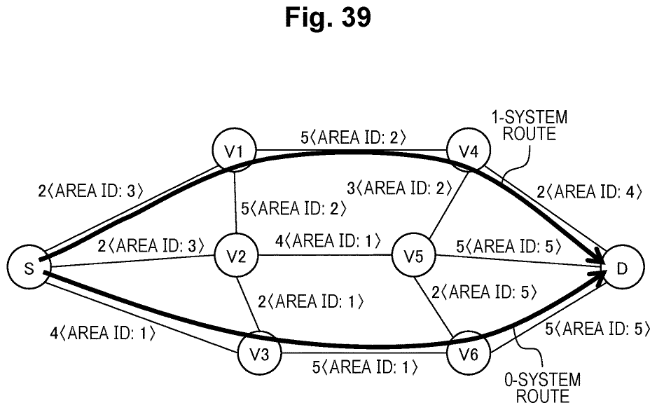

FIG. 39 is a view for explaining outline of processing of the route search device 1 according to Modification 2.

In the above-described embodiment, the SRLG has been described as a conduit in which an optical fiber, or the like, is installed. However, the SRLG is not limited to the conduit, and for example, the SRLG may be associated with an area. In this case, for example, an area ID for each area according to a disaster likelihood is defined as the SRLG information.

FIG. 39 illustrates route design in a case where the area ID is added as the SRLG information. For example, in a case where the route search device 1 passes through the edge E having an area ID: 1 in the 0-system route (main route), the route search device 1 is designed not to pass through the edge E having an area ID: 1 in the 1-system route (redundant route). For example, in a case where the area with the area ID: 1 set by the 0-system route is an area where liquefaction due to an earthquake is predicted, the 1-system route is designed to pass through an area with the area ID (other than the area ID: 1) of an area where countermeasures against liquefaction due to an earthquake have been taken. In addition, the route search device 1 can specify an area where flooding is predicted during a typhoon or heavy rain with the area ID and design a route while selecting a route that does not overlap with the area ID of the specified area in the 1-system route.

### <<Modification 3>>

In the route search device 1 according to the present embodiment, the SRLG information recorded in the route information DB 42 (see FIG. 2) is stored in the order of the SRLG information attached to the edge E of the route passed so far in each route candidate. However, the route search device 1 according to Modification 3 may sort and hold the SRLG information of the routes passed so far in ascending order of SRLG ID.

In this way, the route search device 1 can increase speed of checking overlapping with the SRLG ID (SRLG information) of the target edge by performing search with “O (log n) ” using a tree structure. This is particularly effective in a case where route search is performed in a large-scale network.

### <<Modification 4>>

The route search device 1 according to the present embodiment has been described assuming that the logical edge is different from the physical edge as illustrated in FIGS. 40A and 40B. For example, the logical edge A-B corresponds to <conduit 1> and <conduit 2> as physical edges.

Here, if the logical edge and the physical edge correspond to each other on a one-to-one basis, SRLG ID is assigned in such a manner that the logical edge corresponds to the physical edge (conduit information) corresponding to each other on a one-to-one basis. As a result, the route search device 1 according to Modification 4 can implement edge-disjoint route generation between the systems.

### <Effects>

Hereinafter, effects of the route search device 1, and the like, according to the present invention will be described.

A route search device according to the present invention is a route search device 1 that searches for a 0-system route that is a main route and a 1-system route that is a redundant route, which are routes from a start point node to an end point node, in a network including a plurality of nodes N connected by edges E. The route search device 1 includes: a storage unit 4 that stores cost and SRLG information set to each of the edges E; a section division unit 31 that sets a search section from the start point node via the end point node to the start point node again and divides the set search section into a plurality of sections; and a route search unit 32 that creates a route of the entire search section by sequentially searching for a route in each section based on the cost set to each of the edges E and creates the 0-system route and the 1-system route by dividing the route of the entire search section at the end point node. When the route in each section is sequentially searched, the route search unit 32 records the searched route and the SRLG information of an edge indicated by the route, and when a route in a next section is searched for, the route search unit searches for a route that does not overlap with a route in a previous section and searches for a route in each section from the end point node to the start point node so that the SRLG information does not overlap with the SRLG information of the route searched for in each section from the start point node to the end point node.

According to this configuration, the route search device 1 can search for a plurality of routes avoiding overlapping of an SRLG while suppressing cost of each route.

Specifically, the route search device 1 can create a 0-system route and a 1-system route by setting a search section from the start point node S via the end point node D to the start point node S again, performing search processing, and finally dividing a route of the created search section at the end point node D.

Further, the route search unit 32 performs search processing based on the cost set to each of the edges E while recording the searched route and the SRLG information of the route in each section obtained by dividing the search section. As a result, the route search device 1 can suppress cost of each route and search for a route avoiding overlapping of the SRLG in the 0-system route and the 1-system route.

In addition, in the route search device 1, in a case Where different via nodes are designated for each of the 0-system route and the 1-system route, the section division unit 31 arranges the via node of the 0-system route in a section from the start point node to the end point node and arranges the via node of the 1-system route in a section from the end point node to the start point node in setting of the search section, the section division unit 31 divides the search section into a plurality of sections having the start point node, the end point node, and the via nodes as terminal points, and the route search unit 32 searches for a route while allowing overlapping of the SRLG information in a plurality of sections of the 0-system route and the 1-system route and searches for a route in which the SRLG information does not overlap between the 0-system route and the 1-system route.

In this way, even in a case where the via nodes are designated in the 0-system route and the 1-system route, the route search device 1 can search for a route in which the SRLG information does not overlap between the 0-system route and the 1-system route.

Further, in the route search device 1, in a case where two or more system routes that are additional redundant routes are searched for in addition to the 0-System route and the 1-system route as routes from the start point node to the end point node, the section division unit 31 extends an end terminal of the search section according to the number of additional routes, and the route search unit searches for a route so that the SRLG information does not overlap with SRLG information recorded in a route searched for in a system prior to the own system in search of two or more system routes.

In this way, the route search device 1 can search for many redundant routes with no overlapping SRLG within a searchable range.

In addition, in the route search device 1, for a node selected as a route in one system at the time of searching for a route in each system, whether or not the node can be redundantly selected in a route of another system is stored in the storage unit 4 as attribute information of each node N. When a route in each section is sequentially searched for, if there is a node for which the SRLG information does not overlap with SRLG information recorded in a route searched for in another system and for which node overlapping with a route of another system is possible based on the attribute information of the node, the route search unit 32 searches for a route including the node.

In this way, the route search device 1 can store a node for which node overlapping between systems is possible as an attribute for each node, so that it is possible to flexibly design a route with no overlapping of the SRLG according to a situation for each node.

For example, by allowing node overlapping between systems for a node having high processing performance or a node installed in a building having high seismic performance, it is possible to increase a possibility of performing appropriate route design while avoiding risks.

In addition, in the route search device 1, the route search unit 32 sequentially searches for a route in each section, and, when the SRLG information of an edge indicated by a newly searched route is added, the route search unit 32 sorts and records the SRLG information including SRLG information of routes searched so far in ascending order.

In this way, the route search device 1 can perform search with “O (logz)” (here, z is the number of groups of the SRLG) using a tree structure and can increase speed of checking overlapping with the SRLG information of the target edge.

In the route search device 1, the SRLG information is an identifier of a conduit which is a physical communication path connecting the nodes or an identifier of an area in which an edge between the nodes is installed.

In this manner, the route search device 1 can set the SRLG information in units of a conduit or in units of an area. This results in making it possible to implement route search while an actual situation in which a node and an edge are installed is reflected as the SRLG information.

Note that the present invention is not limited to the above-described embodiment, and many modifications can be made by those skilled in the art within the technical idea of the present invention.

### REFERENCE SIGNS LIST

1 Route search device
2 Input/output unit
3 Control unit
4 Storage unit
31 Section division unit
32 Route search unit
41 Network information DB
42 Route information DB
421 Route list
422 Final list
9 Management device
N Node
S Start point node
D End point node
V1 to V6 Node
E Edge
NW Optical path network

1. A route search device that searches for a 0-system route that is a main route and a 1-system route that is a redundant route, which are routes from a start point node to an end point node, in a network including a plurality of nodes connected by edges, the route search device comprising:
one or more memory devices; and
one or more central processors configured to perform operations including:
storing cost and shared risk link group (SRLG) information set to each of the edges;
setting a search section from the start point node via the end point node to the start point node again and divide the set search section into a plurality of sections; and
creating a route of an entire search section by sequentially searching for a route in each section based on the cost set to each of the edges and create the 0-system route and the 1-system route by dividing the route of the entire search section at the end point node,
wherein based on a route in each section being sequentially searched for, the one or more central processors is configured to perform operations including recording the searched route and the SRLG information of an edge indicated by the route, and based on a route in a next section being searched for, the one or more central processors is configured to perform operations including searching for a route that does not overlap with a route in a previous section and searching for a route in each section from the end point node to the start point node so that the SRLG information does not overlap with the SRLG information of the route searched for in each section from the start point node to the end point node.

2. The route search device according to claim 1, wherein
based on different via nodes being designated for each of the 0-system route and the 1-system route, the one or more central processors is configured to perform operations including:
arranging the via node of the 0-system route in a section from the start point node to the end point node;
arranging the via node of the 1-system route in a section from the end point node to the start point node in setting of the search section;
dividing the search section into the plurality of sections having the start point node, the end point node, and the via nodes as terminal points, and
searching for a route while allowing overlapping of the SRLG information in a plurality of sections of the 0-system route and the 1-system route; and
searching for a route in which the SRLG information does not overlap between the 0-system route and the 1-system route.

3. The route search device according to claim 2, wherein
the one or more central processors is configured to perform operations including:
extending an end terminal of the search section according to a number of additional routes based on two or more system routes that are additional redundant routes being searched for in addition to the 0-system route and the 1-system route as routes from the start point node to the end point node, and
searching for a route so that the SRLG information does not overlap with SRLG information recorded in a route searched for in a previously searched system prior to the presently being searched system in search of two or more system routes.

4. The route search device according to claim 1, wherein:
the one or more central processors is configured to perform operations including:
storing attribute information of each node, for a node selected as a route in one system at a time of searching for a route in each system, the attribute information comprising whether or not the node can be redundantly selected in a route of another system; and
searching for a route including the node, based on a route in each section being sequentially searched for, if there is a node for which the SRLG information does not overlap with SRLG information recorded in a route searched for in another system and for which a node overlapping with a route of another system is possible based on the attribute information of the node.

5. The route search device according to claim 1,
wherein the the one or more central processors is configured to perform operations including:
sequentially searching for a route in each section, and based on the SRLG information of an edge indicated by a newly searched route being added, sorting and recording the SRLG information including SRLG information of routes searched so far in ascending order.

6. The route search device according to claim 1, wherein the SRLG information is an identifier of a conduit which is a physical communication path connecting the nodes or an identifier of an area in which an edge between the nodes is installed.

7. A route search method of a route search device that searches for a 0-system route that is a main route and a 1-system route that is a redundant route, which are routes from a start point node to an end point node, in a network including a plurality of nodes connected by edges, the route search device comprising a storage unit that stores a cost and SRLG information set to each of the edges,
the route search method comprising:
setting a search section from the start point node via the end point node to the start point node again and dividing the set search section into a plurality of sections;
creating a route of an entire search section by sequentially searching for a route in each section based on the cost set to each of the edges and creating the 0-system route and the 1-system route by dividing the route of the entire search section at the end point node; and
recording the searched route and the SRLG information of an edge indicated by the route based on a route in each section being sequentially searched for in the route search processing, based on a route in a next section being searched, searching for a route that does not overlap with a route in a previous section and searching for a route in each section from the end point node to the start point node so that the SRLG information does not overlap with the SRLG information of the route searched in each section from the start point node to the end point node.

8. A route search program for causing a computer to function as the route search device according to claim 1.
